(19) United States
(12) Patent Application Publication
(10) Pub. No.: US 2002/0052858 A1
(43) Pub. Date: May 2, 2002

(54) Method and tool for data mining in automatic decision making systems

(75) Inventors: Arnold J. Goldman, Jerusalem (IL); Jehuda Hartman, Rehovot (IL); Joseph Fisher, Jerusalem (IL); Shlomo Sarel, Yosh (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Insyst Ltd.

(21) Appl. No.: 10/000,168

(22) Filed: Dec. 4, 2001

Related U.S. Application Data
(63) Continuation-in-part of application No. 09/633,824, filed on Aug. 7, 2000.
(63) Continuation-in-part of application No. 09/588,681, filed on Jun. 7, 2000.
(63) Continuation-in-part of application No. 09/731,978, filed on Dec. 8, 2000.
(60) Provisional application No. 60/262,083, filed on Jan. 18, 2001.

(30) Foreign Application Priority Data
Oct. 31, 1999 (IL) 132663

(51) Int. Cl. G06F 15/18

(52) U.S. Cl. 706/15

(57) ABSTRACT

Apparatus and associated method for constructing a quantifiable model, comprising: an object definer for converting user input into at least one cell having inputs and outputs, a relationship definer for converting user input into relationships associated with said cells such that each said relationships is associatable with said cells via one of said inputs and outputs, a quantifier for analyzing a data set to be modeled to assign quantitative values to said relationships and to associate said quantitative values with said associated inputs and outputs, thereby to generate a quantitative model. The model is useful in automatic decision-making and process control and for process simulation and study. The model building methodology provides for structured and quantity reduced investigation of process data since a qualitative model is used to guide the data analysis. The methodology also allows for obtaining new information regarding such a process through the resulting quantitative model.

The present application claims priority from U.S. Provisional Patent Application No. 60/262,083 filed Jan. 18, 2001, and is a continuation in part of each of the following applications U.S. patent application Ser. No. 09/633,824, filed Aug. 7, 2000, U.S. application Ser. No. 09/588,681, of Jun. 7, 2000, and Ser. No. 09/731,978, of Dec. 8, 2000. In addition, Israel Patent Application Ser. No. IL/132663 filled Oct. 31, 1999 is hereby incorporated herein by reference as are each of the above applications, for all purposes as if fully set forth herein.

### BACKGROUND OF THE INVENTION

The present invention relates to the formation and the application of a knowledge base in general and in the area of data mining and automated decision making in particular.

The present invention is also related to the following co-pending patent applications of Goldman, et al. which utilize it's teaching:

U.S. patent application Ser. No. 09/633,824 filled Aug. 7, 2000, and U.S. Patent Application entitled—“System and Method for Monitoring Process Quality Control” filled Oct. 13, 2000 (hereinafter the POEM Application) which are incorporated by reference for all purposes as if fully set forth herein.

Automatic decision-making is based on the application of a set of rules to score values of outcomes, which results from the application of a predictive quantitative model to new data.

The predictive quantitative model (sometimes referred to as an empirical model) is typically established by using a procedure called data mining.

Data mining describes a collection of techniques that aim to find useful but undiscovered patterns in collected data. A main goal of data mining is to create models for decision making that predict future behavior based on analysis of past activity.

Data mining extracts information from an existing data-base to reveal patterns of relationship between objects in that data-base. The patterns need neither be known beforehand nor intuitively expected.

The term “data mining” expresses the idea of excavating a mountain of data. The data mining algorithm serves as the excavator and shifts through vast quantities of raw data looking for valuable nuggets of information.

However, unless the output of the data mining process can be understood qualitatively, it is of little use. I.e. a user needs to view the output of the data mining in a context meaningful to his goals, and to be able to disregard irrelevant patterns.

Data mining thus necessarily involves a perception stage and it is in this perception stage in which human reasoning, hereinafter referred to as expert input, is needed to assess the validity and evaluate the plausibility and relevancy of the correlations found in the automated data mining. It is that indispensable expert input that forms a barrier to the design of a completely automated decision making system.

Several attempts have been made to eliminate the aforesaid need for expert input, typically by automatic organization or a priori restricting the vast repertoire of relationship patterns which may be expected to be exposed by the data mining algorithm.

U.S. Pat. No. 5,325,466 to Kornacker describes the partition of a database of case records into a tree of conceptually meaningful clusters wherein no prior domain-dependent knowledge is required.

U.S. Pat. No. 5,787,425 by Bigus describes an object oriented data mining framework which allows the separation of the specific processing sequence and requirement of a specific data mining operation from the common attribute of all data mining operations. More specifically, an object oriented framework for data mining operates upon a selected data source and produces a result file. Certain core functions in the operation are catered for and performed by the framework, which interact with separable extensible functionality. The separation of core and extensible functions allows a separation between specific processing sequences and requirements of a specific data mining operation on the one hand and common attributes of all data mining operations on the other hand. The user is thus enabled to define extensible functions that allow the framework to perform new data mining operations without the framework having to know anything about the specific processing required by those operations.

U.S. Pat. No. 5,875,285 to Chang describes an object oriented expert system which is an integration of an object oriented data mining system with an object oriented decision making system and U.S. Pat. No. 6,073,138 to de l'Etraz, et al. discloses a computer program for providing relational patterns between entities.

Recently, a concept known as dimension reduction has been applied in order to reduce the vast numbers of relations often identified by data mining operations, particularly when operating on large data sets.

Dimension reduction selects relevant attributes in the dataset prior to performing data mining, important in guaranteeing the accuracy of further analysis as well as for performance. As redundant and irrelevant attributes may mislead any such analysis, the inclusion of all of the attributes in the data mining procedures not only increases the complexity of the analysis, but also degrades the accuracy of any results.

Dimension reduction improves the performance of data mining techniques by reducing dimensions so as to reduce the number of attributes. With dimension reduction, improvement in orders of magnitude is possible.

The conventional dimension reduction techniques are not easily applied to data mining applications directly (i.e., in a manner that enables automatic reduction) because they often require a priori domain knowledge and/or arcane analysis methodologies that are not well understood by end users. Typically, it is necessary to incur the expense of a domain expert with knowledge of the data in a database to determine which attributes are important for data mining. Some statistical analysis techniques, such as correlation tests, have been applied for dimension reduction. However, such techniques are ad hoc and assume a priori knowledge of the dataset, which cannot always be assumed to be available. Moreover, conventional dimension reduction techniques are not designed for processing the large datasets that may be involved.

In order to overcome the above drawbacks in conventional dimension reduction, U.S. Pat. No. 6,032,146 and U.S. Pat. No. 6,134,555 both by Chadra, et al. disclose an automatic dimension reduction technique applied to data mining in order to identify important and relevant attributes for data mining without the need for the expert input of a domain expert.

A disadvantage of the above is that, being completely automatic, such a dimension reduced data mining procedure is a black box for most end users who are forced to rely on its findings without having any easy way of analyzing the basis for those findings.

It is the view of the present inventors that defining relevancy between objects and events is intrinsically a human act and cannot be replaced by a computer at the present time. Furthermore, most end users of an automatic decision making system would like to be involved in the decision making process at the conceptual level. I.e. they would wish to visualize the links between factors which affect the final decision made or outcome predicted. The end users would further wish to contribute to the data mining algorithm itself by making their own suggestions as to influential attributes and cause and effect relationships.

Thus, the expert input to route and navigate the data mining according to a human knowledge and perception schemes is regarded as beneficial. However, it must also be borne in mind that the data sets on which data mining is carried out are often very large and it can often be impractical to expect experts to be able to make a meaningful qualitative analysis.

There is therefore a need in the art for an improved method and tool for the data mining of large datasets which includes an a priori qualitative modeling of the system at hand and which enables automatic use of the quantitative relations disclosed by a dimension reduced data mining in automatic decision-making.

### SUMMARY OF THE INVENTION

Embodiments of the present invention allow the automated coupling between the stages of data mining and score prediction in an automatic decision-making system.

A conceptualization format referred to as a knowledge tree (KT) provides a method of representing sequences of relations among objects, where those relations are not detectable by current means of knowledge engineering and wherein such a conceptualization is used to reduce the dimension of data mining, a requisite stage in automatic decision-making.

The KT preferably enables automatic creation of meaningful connections and relations between objects, when only general knowledge exists about the objects concerned.

The KT is especially beneficial when a large base of data exists, as other tools often fail to depict the correct relations between participating objects.

According to a first aspect of the present invention there is provided apparatus for constructing a quantifiable model, the apparatus comprising:

an object definer for converting user input into at least one cell having inputs and outputs,

a relationship definer for converting user input into relationships associated with said cells such that each said relationships is associatable with said cells via one of said inputs and outputs,

a quantifier for analyzing a data set to be modeled to assign quantitative values to said relationships and to associate said quantitative values with said associated inputs and outputs, thereby to generate a quantitative model.

The apparatus may additionally comprise a verifier for verifying at least one relationship, said verifier comprising determination functionality for determining whether said associated quantitative value is above a threshold value and deletion functionality for deleting said associated input or output if said quantitative value is below said threshold value.

Preferably, said quantifier comprises a statistical data miner.

Preferably, said quantifier comprises any one of a group including: linear regression, nearest neighbor, clustering, process output empirical modeling (POEM), classification and regression tree (CART), chi-square automatic interaction detector (CHAID) and neural network empirical modeling.

Preferably, said data is a predetermined empirical data set.

Preferably, said data is a preobtained empirical data set describing any one of a group comprising a biological process, sociological process, a psychological process, a chemical process, a physical process and a manufacturing process.

According to a second aspect of the present invention there is provided apparatus for studying a process having an associated empirical data set, the apparatus comprising:

an object definer for converting user input into at least one cell having inputs and outputs,

a relationship definer for converting user input into relationships associated with said cells such that each said relationships is associatable with said cells via one of said inputs and outputs,

a quantifier for analyzing said associated empirical data set to assign quantitative values to said relationships and to associate said quantitative values with said associated inputs and outputs, thereby to generate a quantitative model.

The apparatus may additionally comprise a verifier for verifying at least one relationship, said verifier comprising determination functionality for determining whether said associated quantitative value is above a threshold value and deletion functionality for deleting said associated input or output if said quantitative value is below said threshold value.

Preferably, said quantifier comprises a statistical data miner.

Preferably, the quantifier comprises functionality for any one of a group including: linear regression, nearest neighbor, clustering, process output empirical modeling (POEM), classification and regression tree (CART), chi-square automatic interaction detector (CHAID) and neural network empirical modeling.

Preferably, said data is a predetermined empirical data set of said process.

Preferably, said process comprises any one of a group comprising a biological process, sociological process, a psychological process, a chemical process, a physical process and a manufacturing process.

According to a third aspect of the present invention there is provided apparatus for constructing a predictive model for a process, the apparatus comprising:

an object definer for converting user input into at least one cell having inputs and outputs,

a relationship definer for converting user input into relationships associated with said cells such that each said relationships is associatable with said cells via one of said inputs and outputs,

a quantifier for analyzing a data set relating to said process to be modeled to assign quantitative values to said relationships and to associate said quantitative values with said associated inputs and outputs, thereby to generate a model predictive of said process.

The apparatus of the third aspect may additionally comprise a verifier for verifying at least one relationship, said verifier comprising determination functionality for determining whether said associated quantitative value is above a threshold value and deletion functionality for deleting said associated input or output if said quantitative value is below said threshold value.

Preferably, said quantifier comprises a statistical data miner.

Preferably, said quantifier comprises functionality for any one of a group including: linear regression, nearest neighbor, clustering, process output empirical modeling (POEM), classification and regression tree (CART), chi-square automatic interaction detector (CHAID) and neural network empirical modeling.

Preferably, the data is a predetermined empirical data set of said process.

Preferably, said process comprises any one of a group comprising a biological process, sociological process, a psychological process, a chemical process, a physical process and a manufacturing process.

The apparatus may additionally comprise an automatic decision maker for using said predictive model together with state readings of said process to make feed forward decisions to control said process.

According to a fourth aspect of the present invention there is provided apparatus for reduced dimension data mining comprising:

an object definer for converting user input into at least one cell having inputs and outputs,

a relationship definer for converting user input into relationships associated with said cells such that each said relationships is associatable with said cells via one of said inputs and outputs,

a quantifier for analyzing a data set relating to a process to be modeled comprising a selective data finder to find data items associated with said relationships and ignore data items not related to said relationships, said quantifier being operable to use said found data to assign quantitative values to said relationships and to associate said quantitative values with said associated inputs and outputs.

The apparatus may additionally comprise a verifier for verifying at least one relationship, said verifier comprising determination functionality for determining whether said associated quantitative value is above a threshold value and deletion functionality for deleting said associated input or output if said quantitative value is below said threshold value.

Preferably, said quantifier comprises a statistical data miner.

Preferably, the quantifier comprises functionality for any one of a group including: linear regression, nearest neighbor, clustering, process output empirical modeling (POEM), classification and regression tree (CART), chi-square automatic interaction detector (CHAID) and neural network empirical modeling.

Preferably, the data is a predetermined empirical data set of said process.

Preferably, the process comprises any one of a group comprising a biological process, sociological process, a psychological process, a chemical process, a physical process and a manufacturing process.

According to a fifth aspect of the present invention there is provided a method of constructing a quantifiable model, comprising:

converting user input into at least one cell having inputs and outputs,

converting user input into relationships associated with said cells such that each said relationship is associated with said cells via one of said inputs and outputs,

analyzing a data set to be modeled to assign quantitative values to said relationships and to associate said quantitative values with said associated inputs and outputs, thereby to generate a quantitative model.

According to a sixth aspect of the present invention there is provided a method for reduced dimension data mining comprising:

converting user input into at least one cell having inputs and outputs,

converting user input into relationships associated with said cells such that each said relationship is associated with said cells via one of said inputs and outputs,

analyzing a data set relating to a process to be modeled comprising a finding data items associated with said relationships and ignoring data items not related to said relationships, and using said found data to assign quantitative values to said relationships and to associate said quantitative values with said associated inputs and outputs.

According to a seventh aspect of the present invention there is provided a knowledge engineering tool for verifying an alleged relationship pattern within a plurality of objects, the tool comprising

a graphical object representation comprising a graphical symbolization of the objects and assumed interrelationships, said graphical symbolization including a plurality of interconnection cells each representing one of said objects, and inputs and outputs associated therewith, each qualitatively representing an alleged relationship, and

a quantifier for analyzing a data set of said objects to assign quantitative values to said relationships and to associate said quantitative values with said alleged relationships, thereby to verify said alleged relationships.

Preferably, said quantifier comprises a selective data finder to find data items associated with said relationships and ignore data items not related to said relationships such that only said found data are used in assigning quantitative values to said relationships and associating said quantitative values with said associated inputs and outputs.

The apparatus may additionally comprise automatic initial layout functionality for arranging said inputs and outputs as interconnections between said cells and independent inputs and independent outputs in accordance with an a priori structural knowledge of said system.

Preferably, said automatic initial layout functionality is configured to derive layout information from any one of a group consisting of process flow diagrams, process maps, structured questionnaire charts and layout drawings of said system.

Preferably, one of said inputs is either a measurable input or a controllable input.

Preferably, an output of a first of said interconnection cells comprises an input to a second of said interconnection cells.

Preferably, the output is a controllable output to said first interconnection cell and a measurable input to said second interconnection cell.

According to an eighth aspect of the present invention there is provided a machine readable storage device, carrying data for the construction of:

an object definer for converting user input into at least one cell having inputs and outputs,

a relationship definer for converting user input into relationships associated with said cells such that each said relationships is associatable with said cells via one of said inputs and outputs, and

a quantifier for analyzing a data set to be modeled to assign quantitative values to said relationships and to associate said quantitative values with said associated inputs and outputs, thereby to generate a quantitative model.

According to a ninth aspect of the present invention there is provided data mining apparatus for using empirical data to model a process, comprising:

a data source storage for storing data relating to a process,

a functional map for describing said process in terms of expected relationships,

a relationship quantifier, connected between said data source storage and said functional process map, for utilizing data in said data storage to associate quantities with said expected relationships,

thereby to provide quantified relationships to said functional map, thereby to model said process.

The apparatus may additionally comprise a functional map input unit for allowing users to define said expected relationships, thereby to provide said functional map.

The apparatus may additionally comprise a relationship validator associated with said relationship quantifier to delete relationships from said model having quantities not reaching a predetermined threshold.

According to a tenth aspect of the present invention there is provided apparatus for obtaining new information regarding a process having an associated empirical data set, the apparatus comprising:

an object definer for converting user input into at least one cell having inputs and outputs,

a relationship definer for converting user input into relationships associated with said cells such that each said relationships is associable with said cells via one of said inputs and outputs,

a quantifier for analyzing said associated empirical data set to assign quantitative values to said relationships and to associate said quantitative values with said associated inputs and outputs, thereby to generate a quantitative model, said quantitative values comprising new information of said process.

The apparatus may additionally comprise a verifier for verifying at least one relationship, said verifier comprising determination functionality for determining whether said associated quantitative value is above a threshold value and deletion functionality for deleting said associated input or output if said quantitative value is below said threshold value.

Preferably, said quantifier comprises a statistical data miner.

Preferably, said quantifier comprises functionality for any one of a group including: linear regression, nearest neighbor, clustering, process output empirical modeling (POEM), classification and regression tree (CART), chi-square automatic interaction detector (CHAID) and neural network empirical modeling.

Preferably, said data is a predetermined empirical data set of said process.

Preferably, said process comprises any of a biological process, a sociological process, a psychological process, a chemical process, a physical process and a manufacturing process.

Other objects and benefits of the invention will become apparent upon reading the following description taken in conjunction with the accompanying drawings.

### BRIEF DESCRIPTION OF THE DRAWINGS

For a better understanding of the invention, and to show how the same may be carried into effect, reference will now be made, purely by way of example, to the accompanying drawings, in which:

FIG. 1A depicts a structure of a protocol system, which includes a Knowledge-Tree,

FIG. 1B is a pyramid diagram depicting stages prior art technology for automatic decision-making,

FIG. 1C depicts technology for automatic decision-making according to a first embodiment of the present invention,

FIG. 2 is a simplified block diagram of a device according to a first embodiment of the present invention,

FIG. 3. depicts a typical part of a knowledge tree map,

FIG. 4 shows a knowledge tree map useful in medical diagnosis,

FIG. 5 shows a knowledge tree map for building a credit score,

FIG. 6A shows an example of a simple process map, and

FIG. 6B shows the map of FIG. 6A as it may be translated to form a functional knowledge tree map,

FIG. 7 shows a typical stage in the process of FIG. 6B,

FIG. 8 shows the process map of FIG. 6B in which controllable inputs were added to various stages,

FIG. 9 shows the process map of FIG. 6B in which interrelations between stages and outer influences are indicated,

FIG. 10 shows a stage in a given process with all of the various types of relationship in which the stage participates.

FIG. 11 shows an interconnection cell for a particular aspect of the output of a stage in a process,

FIG. 12 shows a plurality of interconnection cells mutually connected with all of the various types of relationship in which the stages participate,

FIG. 13 is a simplified diagram showing a possible knowledge tree cell for managing a clinical trial for studying liver toxicity effects of a drug,

FIG. 14 is a simplified diagram showing a per patient knowledge tree for the clinical trial of FIG. 13, and

FIG. 15 shows a knowledge tree map according to an embodiment of the present invention, useful in microelectronic fabrication processes.

### DETAILED EMBODIMENTS OF THE INVENTION

Reference is firstly made to U.S. patent application Ser. No. 09/588,681, which describes a knowledge-engineering protocol-suit, comprising a generic learning and thinking system, which performs automatic decision-making to run a process control task.

The system described therein has a three-tier structure consisting of an Automated Decision Maker (ADM), a Process Output Empirical Modeler (POEM) and a knowledge tree (KT).

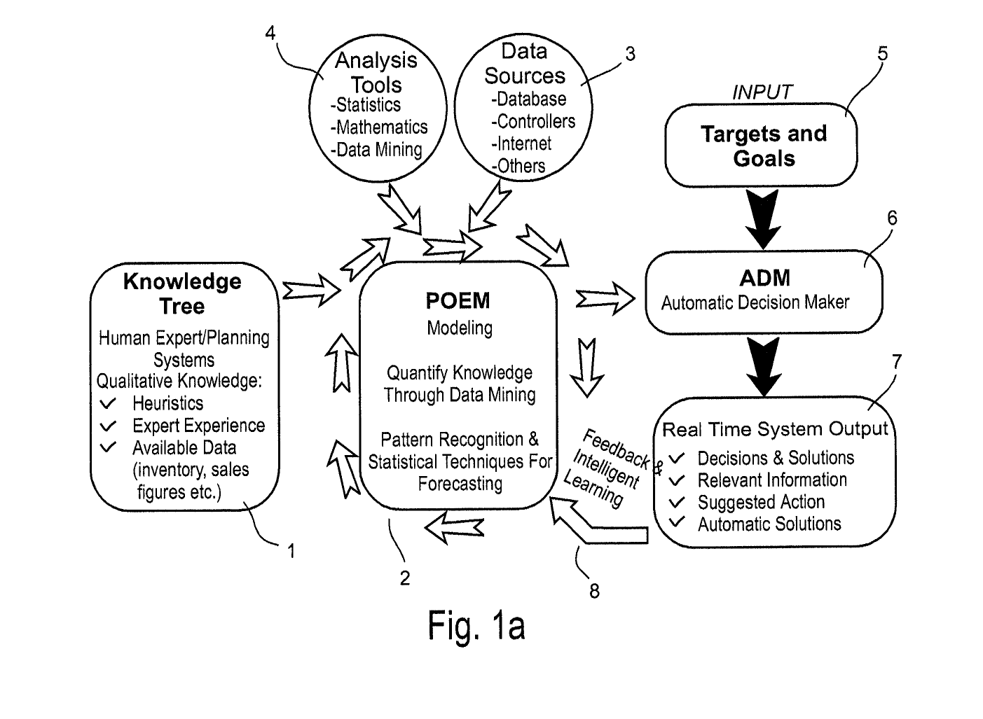

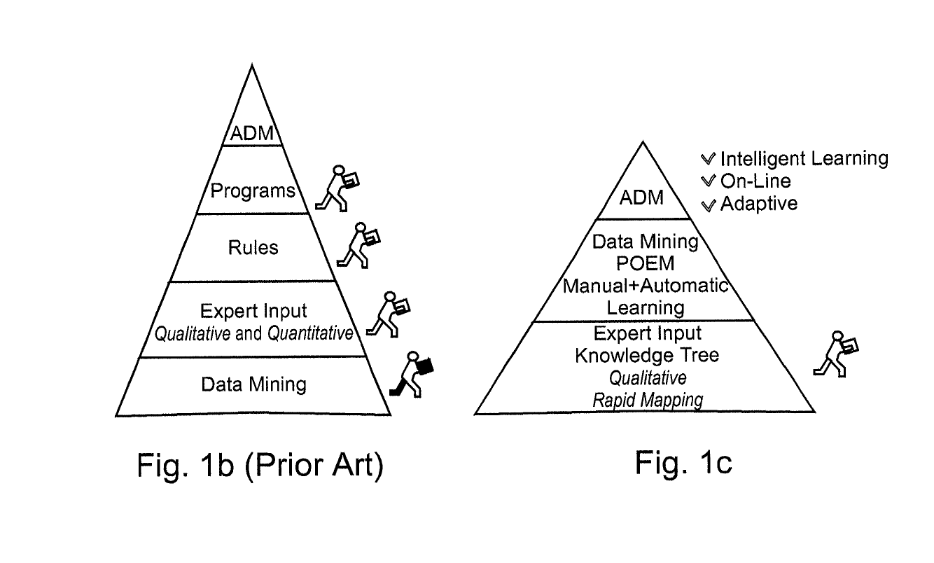

A schematic partial layout of a structure of a protocol-suite of U.S. patent application Ser. No. 09/588,681 is shown in FIG. 1 to which reference is now made.

FIG. 1A is a simplified diagram of a modeling and decision making process. In FIG. 1, a knowledge tree 1 is built up from qualitative information of a system.

The knowledge tree 1 consists of a series of cells arranged in a tree in such a way that the positions of the cells in the tree relate to behavior of a real life system, the cells themselves relating to objects or stages in the real life system. The choice of cells is preferably made by an expert and the choice of relationships between cells may also be made by the expert or may be made automatically and then modified following expert input.

The formal procedure of forming a knowledge tree is a multi step process, which may include the following steps:

(1) Establishing a uniform nomenclature for referring to each of a plurality of objects or stages in a process that it is desired to model.

(2) Collecting an ensemble of template-type questionnaires from a plurality of experts (not necessarily of homogeneous status). Each questionnaire should contain views of one of the experts relating to significant factors affecting performance of one or more of the objects or performance in one or more of the stages as appropriate.

(3) Unifying each template to relate to the uniform nomenclature selected in step 1 above so that the experts comments are recognizable in terms of nodes, edges, cells or combinations thereof (contiguous or otherwise).

(4) Building a knowledge tree (using known graph theoretic techniques) from the nomenclature unified templates or using a process map (if a process map exists) including template suggested relationships from the collected expert suggested relationships.

Following building of the knowledge tree, a stage is carried out of modeling quantitatively, relationships within the data to apply quantities to interconnections between cells in the tree.

In the modeling stage a quantitative modeler 2 is used to apply quantitative values to the nodes and interconnections of the knowledge tree 1. The quantitative modeler 2 makes use of data sources 3, and analysis tools 4. The data sources 3 generally comprise empirically obtained values of the inputs and outputs of the process being modeled.

Typical analysis tools may be any suitable system for statistically processing data, such as linear regression, nearest neighbor, clustering, process output empirical modeling (POEM), classification and regression tree (CART), chi-square automatic interaction detector (CHAID) and neural network empirical modeling.

The knowledge tree 1 is a qualitative component that integrates physical knowledge and logical understanding into a homogenous knowledge structure in a form of a process map known as a knowledge tree map, according to which a quantitative technique, here the POEM algorithmic approach described in the POEM application referred to above, is applied, thereby to obtain a quantified model.

Once a quantified model is established then targets and goals 5 are selected for the corresponding real life process. The quantified model preferably has predictive abilities with respect to the behavior of the system that is being modeled, meaning that inputs and outputs in the system can be followed through the knowledge tree to predict future states. The predictive ability of the quantified model can be used to construct a decision tree to assign scores to attributes of a final object in the sequence of related objects. Such a decision tree is used to form an automated decision maker (ADM) 6, and the ADM 6 can be used to control the process to achieve the intended targets and goals 5 thereby to constrain the real time system output 7 to achieve desired objectives.

Feedback and intelligent learning 8 may be incorporated into the arrangement to allow the quantitative model to adapt over time.

In FIG. 1A, The KT is the qualitative and fundamental component of the protocol system that integrates physical knowledge and logical understanding into a homogenous knowledge structure in the form of a process map known as a knowledge tree map. The knowledge tree map comprises a qualitative understanding of the process, to which a quantitative data modeling process may be applied. Such a quantitative data modeling process, used in the above-mentioned disclosure is a modeling process known as POEM.

The KT map, which will be described later in more detail, is a graphical representation of the relations between attributes of a plurality of objects in an observed or controlled system in terms of causes and their effects. I.e., it is the knowledge tree map which defines the attributes of certain objects which influence the attribute of other objects that in turn may affect the score value of the parameter in regard to which the automatic decision is made.

The construction of the knowledge tree preferably precedes the application of the data mining (POEM in FIG. 1A), serving to reduce the size of the data mining task by directing it in such a way as to look for relations among predetermined relevant datasets only.

Once a quantitative version of the model has been established by the application of quantitative analysis to the qualitative model, it is possible to utilize the predictive power of the quantitative model in order to construct a decision tree. The decision tree is typically constructed in accordance with an accumulated score of an attribute of a final object or state in a sequence of related objects or states or the like.

A significant point is that once a KT for a specific project has been established, no further human intervention is required in the remaining stages of the automatic decision-making process. However, the KT itself, as a construct, is available for analysis and thus the system does not have the black box characteristic of the prior art.

Reference is now made to FIGS. 1B and 1C which provide a comparison between prior art methodology and the methodology of the present invention.

FIG. 1B is a pyramid diagram representing the general concept behind prior art data mining and automatic decision making techniques. In FIG. 1B a data mining layer forms the lowermost layer of the pyramid, and is generally the earliest and most quantity intensive part of the process. The relationships obtained by the data mining are then subjected to expert assessment to determine which relationships are important or significant. Rules are then inferred and programs arranged, resulting in an automated decision making system.

Thus, automatic data mining is intercepted by expert input, which is, as was explained above, indispensable in the assessment of the correlations which were revealed by the data mining.

FIG. 1C is the equivalent pyramid diagram for the general concept behind the present invention. As shown in FIG. 1C, relevant relations are defined first and represented in a knowledge tree map and then only those datasets which are associated with the respective relevant relations, are statistically analyzed. Automatic decision making remains at the top of the pyramid.

The present embodiments thus have two major components, the construction of the knowledge tree map and the use of the knowledge tree map to facilitate automated decision making.

The construction of a KT requires stages of knowledge acquisition, perception and representation, these being well known problems with practical and theoretical aspects.

There are several prior disclosures regarding methods and systems for extracting and organizing knowledge into meaningful or useful clusters of information in the form of a tree like representation.

U.S. Pat. No. 5,325,466 to Komacker describes the building of a system, which iteratively partitions a database of case records into a “knowledge tree” which consists of conceptually meaningful clusters.

U.S. Pat. No. 5,546,507 to Staub describes a method and apparatus for generating a knowledge base by using a graphical programming environment to create a logical tree from which such a knowledge base may be generated.

U.S. Pat. No. 4,970,658 to Durbin, et al. describes a knowledge engineering tool for building an expert system, which includes a knowledge base containing “if-then” rules.

In the internet literature; A qualitative model of reasoning in the form of a “thinking state diagram” (http://www.cogsys.co.uk/cake/CAKE.htm) and visual specification of knowledge bases (http://ww.csa.ru/Inst/gorb_dep/artific/IA/ben-last.htm) have been recently introduced.

A general picture emerging from the above mentioned prior art is that insufficient consideration has been given to systematic theoretical elaboration and automatic implementation of what may be called computerized qualitative modeling of relation states between entities or events which are part of an observed system.

In general, modeling and the conceptualization of the flow of events which are independent of us, plays one of the most fundamental processes of the human mind and it is that which allows to adopt software systems to imitate human reasoning, see Bettoni “Constructivist Foundations of Modeling—a Kantian perspective”, (http://www.fhbb.ch/weknow/aqm/IJIS9808.html), the contents of which are hereby incorporated by reference.

A model, according to Bettoni, can be defined as a symbolic representation of objects and their relations, which conforms to our epistemological way of processing knowledge, and a useful model is not so much one which reflects reality (meaning a model that is a copy of the independent relations between objects), but rather one that comprises a working formalization of the order which we ourselves generate from the knowledge and which fulfils the aim for which the model is intended. In other words a useful model is not so much a model that attempts to express in full every separate data relationship regardless of significance but rather is a model which encompasses all that the human observer believes to be sufficient for his purpose.

Taking into account the above proposition on a suitable model, the building of a KT map suitable for ADM raises the following issues:

(a) How one picks up most if not all the potential objects relevant to a certain situation and identifies significant “short range” relations between them.

(b) How one organizes and conceptualizes the information resulting from a plurality of situations into a multilevel logical structure (building the model).

(c) How one validates the model and refines it to ignore irrelevant objects and relations thereof.

(d) How does one exploit the model to reveal unpredicted relationships or to clarify long range or indirect relations between objects, and,

(e) How is the derived model most effectively coupled to an empirical modeler (data mining tool) in an automatic decision-making system.

The embodiments to be described below address these issues by disclosing a way of conceptualizing any sequence of relations among objects. The embodiments make use of KT maps to manifest the conceptualization as an infrastructure layer for an ADM.

As is described in more detail below, the method of modeling which is referred to hereinafter as constructing a knowledge tree, extends beyond commonly used computational methods of information acquisition and analysis followed by decision-making comprised in current Expert systems.

Current rule-based Expert Systems software attempts to simulate the querying and decision-making process of an expert in a given field of expertise, analyzing information through the accumulation of a class of governing rules based on the opinions of one or more experts in that field.

However, the Rule based Expert Systems method is inherently prone to limitation due to its non-systematic and human-dependent approach. This limitation can be understood in terms of resolution. The extent to which an Expert Systems application can delve into a problem is the fixed resolution of that application. The resolution cannot be lowered, meaning that the application is not capable of solving problems of a less specific nature than that of the accumulated class of governing rules. Nor can the resolution level be raised, meaning that the application is not capable of solving problems of a more specific nature than that of the accumulated class of governing rules. Such resolution level inflexibility is overcome in the knowledge tree embodiments to be described below. knowledge tree methodology may be applied at any level of resolution, meaning that the knowledge tree can serve as a problem-solving tool for problems of any level of complexity for a given discipline. The analysis resolution level is defined by the user according to his needs and may be changed at will, as explained below.

Since the method enumerates all combinations of states of input variables, the entire range of possibilities is covered. Hence any situation may be handled by the system. Mathematically the property is referred to as completeness.

Another problematic aspect of the Rule based Expert Systems method is that it is prone to contradiction, due to the fact that more than one expert opinion is usually used when accumulating the class of governing rules. Opinions of different experts can contradict each other, and generally the only means available within the Expert Systems methodology for determining which opinion is correct is time-consuming trial and error. knowledge tree methodology on the other hand, is not based on the collection of a governing set of rules, and the decision-making tools use logical, process relationships provided by the knowledge tree methodology and then validated by data mining techniques to yield a strict mathematical prediction of an outcome for a given chain of events or factors. Thus, there is no possibility of inherent contradiction as there is with Expert Systems. With knowledge tree methodology, expert opinions are used to determine merely what are the possible influences on a given chain of events or factors. The possible influences suggested by the expert are quantatively evaluated so that there is no mere presentation of a decision-making process and there is no collection of governing rules.

Knowledge tree methodology is preferably based on sets of rules. Preferably the structuring of the rules expressed by the knowledge tree allows one to monitor the rule base for contradictions which may result from contradicting expert opinions or simple contradiction between different trees or even contradictions within a single tree. If the rule base is itself derived from underlying data it is less likely to contain contradictions.

The embodiments utilize a method, a tool and system for the modeling of relations between objects, and include processes of integration of acquired physical knowledge and its subjective logical interpretation in terms of “influences” and “outcomes” into a knowledge structure, which is represented graphically by a relationship pattern called a knowledge tree map.

The knowledge tree map is substantially a “cause and result” map among objects. Hereinafter an object is defined as a material or an intangible entity, (e.g. overdraft, wafer, health) or an event, (e.g. polishing). An object is characterized by at least one state or an outcome, which is neither a “physical” state, nor some property of it. Rather it is merely an attribute, which represents whether according to our perception, the object influences in any relevant way some other object.

A relation is defined as any assumed dependency of the state or outcome of an object on the outcome or state of another object.

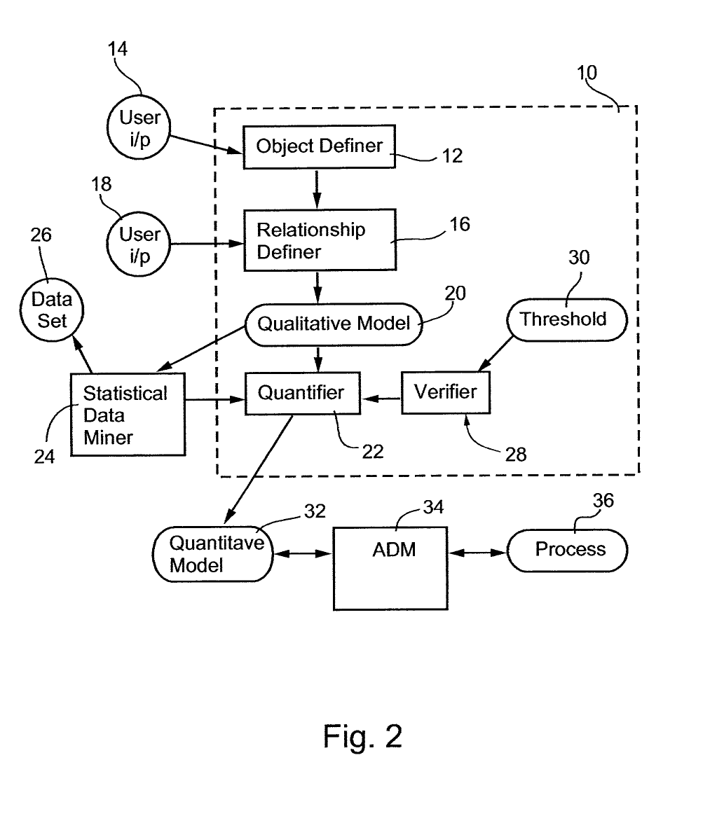

Reference is now made to FIG. 2, which is a simplified block diagram showing apparatus according to a first embodiment of the present invention. FIG. 2 shows apparatus 10 for constructing a quantifiable model.

A first feature of apparatus 10 is an object definer 12, which receives user input 14 and converts the user input into cells having inputs and outputs. Generally the user input 14 relates to a process or system and allows stages in the process or parts of the system to be identified so that they can be understood as objects which are then represented graphically as cells.

Preferably, each cell is represented by a mathematical function f(x₁, . . . xₙ), where x₁, . . . xₙ are the cell input values.

The arrangement of cells produced by the object definer 12 is then passed to a relationship definer 16, which receives user input 18 and converts the user input 18 into relationships associated with the cells. The relationships are expressed in terms of the inputs and outputs to the cells. For example a suggested input-output relationship between two cells is represented by connecting an output of one cell to an input of the other cell. An independent effect on a cell is defined by taking an input to the cell and designating it with the independent input, for example the running temperature of a tool.

The object definer 12 and the relationship definer 16 between them give a qualitative model 20 of the process or system. The relationships defined in the qualitative model may be known relationships or relationships inferred from the structure of the system or process or assumed, unverified relationships or any combination thereof.

The qualitative model 20 is then passed to a quantifier 22, which utilizes a statistical data miner 24 for analyzing a data set 26 in accordance with the relationships incorporated into the qualitative model 20. That is to say the data in the data set is mined only to the extent that it is applicable to the relationships in the model. Relationships in the data that do not relate to relationships shown in the model are not investigated, thus reducing the processing load of investigating the data. There is thus provided what is known as reduced dimension data mining.

Preferably, values for each relationship, as determined by the data mining process, are associated with each of the relationships on the qualitative model, as coefficients, thereby to construct a quantitative model.

The quantitative model resulting from the above is then processed by a verifier 28. The verifier preferably includes a threshold relationship level 30 which is compared with the coefficients associated with the relationships by the quantifier. The threshold 30 may be a simple level or it may be a statistical measure, as will be explained in more detail below. The threshold is used to verify the relationship, and any relationship having a coefficient below the threshold is preferably deleted from the tree. The verifier 28 thus provides a means of validating the initial input and thereby allowing a final verified quantitative model 32 to be created which contains an enrichment of the initial user input.

The statistical data miner 24 may be based on any suitable system for statistically processing data, and may include systems based on linear regression, nearest neighbor, clustering, process output empirical modeling (POEM), classification and regression tree (CART), chi-square automatic interaction detector (CHAID) and neural network empirical modeling.

The process or system being modeled may come from any field of human endeavor or study. Particular examples include biological processes, sociological processes, psychological processes, chemical processes, physical processes and manufacturing processes. Essentially the apparatus of FIG. 2 is applicable to any process or system that can be modeled as interconnected stages and for which an empirical data set can be obtained. As will be described below, particular applications include medical diagnosis and semiconductor manufacture.

As will be discussed in more detail below, the verified quantitative model 32 can be used to predict process outcomes. The coefficients thereon can be used as weightings to actual input values of a process 36 to predict likely outputs and make process decisions as part of an automatic decision maker 34. In addition actual process outputs can be fed back to the model to improve the model.

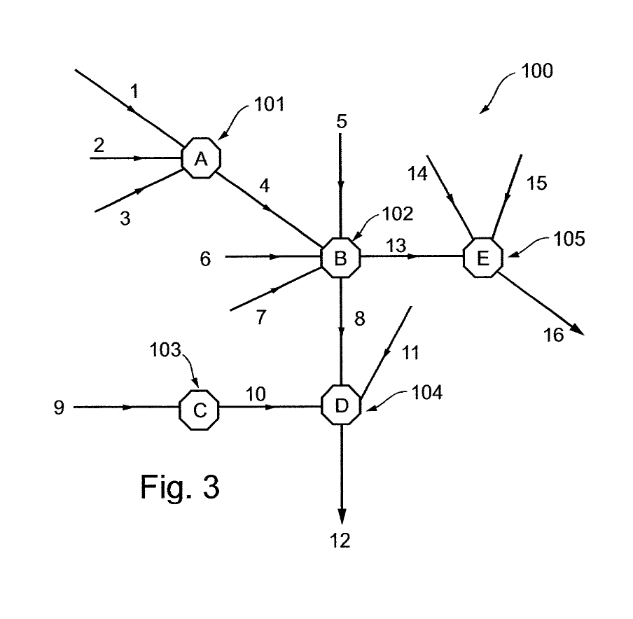

Reference is now made to FIG. 3, which shows a knowledge tree map 100 having five nodes A-E-101-105, and showing interrelationships therebetween. In FIG. 2, reference was made to a graphical representation of the objects and relationships as cells with interconnections, and the knowledge tree map 100 is an example of such a graphical representation. It will be appreciated that the knowledge tree map is suitable for the qualitative model and also for the unverified and the verified quantitative model. In FIG. 3, objects of a scheme, process etc being modeled are represented by the nodes, thus the five nodes labeled A 101, B 102, C 103, D 104, and E 105 represent five different objects.

A state, or an outcome or output, of an object is designated by a pointer (an arrow), which originates from the respective object, while any alleged influence on the state or outcome of an object is designated by a pointer pointing toward that object. Thus there are provided pointers that lead from one node to another which represent outputs of one node serving as an input on another node. Likewise other pointers arrive at nodes but do not emerge from other nodes and these represent object independent influences such as original variables or environmental influences. Again other pointers emerge from nodes but do not lead to other nodes. Such pointers represent the output of the objective function or outputs of states which do not influence other states.

The presence or absence of a pointer is a decision preferably made by an expert according to his judgment, outside of the framework of automatic or advanced processing. The pointers are subsequently used to define routes of data streams which are relevant to the outcome of each object. I.e. only data in datasets which are associated with the pointers are experimentally acquired or extracted in a data mining procedure for processing by a quantitative modeler. Thus the data mining technique is guided by the relationships specified in the knowledge tree to yield quantified functional relations between the objects in the problem at hand.

In FIG. 3 each object produces at least one outcome and objects: A 101, B 102, and C 103 produce outcomes that influence other objects. Arrows 1-11 and 13-15 represent influences that affect an object, and arrows 12 and 16 represent final outcomes at nodes D 104 and E 105 respectively. Arrows 4, 8, 10, and 13 represent intermediary outcomes of objects that are influences on other objects. That is, the object at node A 101 produces an intermediary outcome (arrow 4) that is an influencing factor on the object at node B 102, the object at node C 103 produces an intermediary outcome (arrow 10) that is an influencing factor on the object at node D 104 and the object at node B 102 produces two intermediary outcomes (arrows 8 and 13), where arrow 8 is an influencing factor on the object at node D 104 and arrow 13 is an influencing factor on the object at node E 105.

It will be appreciated that a knowledge tree map may be as large or as small as circumstances require and is in no way limited by the number of nodes and relationships shown in FIG. 3.

In theory, any number of influences is possible, although in practice large numbers will increase complexity. Likewise, there is no limit to the number of outcomes that can be depicted as resulting from an object. In FIG. 3, object B 102 produces two outcomes, and all the other objects produced only one outcome. The cell with the largest set of inputs/influencing parameters may be considered as a complexity bottleneck.

The uniqueness of the knowledge tree map is that it allows the user to represent any kind of process or chain of objects and define what he feels are the relations between the objects in that chain of objects. After experts on a certain object have defined what they perceive as the factors that may influence the state or an outcome at that object, data is collected to validate the potential influences of the suggested factors on the outcomes of the objects they allegedly affect.

Knowledge tree methodology preferably takes data and uses mathematical, statistical or other algorithms for determining a correlation coefficient between an influential factor and the outcome of the affected object.

Influences with a high correlation coefficient are confirmed and are entered into a quantified version of the knowledge tree map as relevant relations between objects.

When completed, the quantified and verified knowledge tree map may present an entirely new conception of how to model relationships between objects, i.e. to perceive the process or chain of objects depicted. Because the knowledge tree methodology requires validation of the hypothesis that a user-defined potential influence affects a particular object, the methodology enables the user to take any number of potential influences which he thinks may in some way influence a given chain of objects, validate the potential influences quantitatively and then present the validated influences in a logical configuration. From a plurality of local cell quantitative models the knowledge tree creates a system overall model.

In the prior art, many potential influences that could be identified were, at best, assumed to influence the chain of objects in some way, but further details such as which object specifically in the chain remained unknown. At worst, it was not clear at all whether the potential influence had any affect on this chain of objects.

A particular feature of the knowledge tree is that the flexibility of connectivity inherent therein allows for indirect influences to be recognized. For example, in FIG. 3, knowledge tree map shows that arrows 8, 10, and 11 are influences on the object at node D 104. However, since arrow 8 is also an outcome of the object at node B 102, all the influences on the object at node B 102 (arrows 4, 5, 6, and 7) are, in effect, indirect influences on the object at node D 104, and this information would have remained unknown without implementing knowledge tree.

Furthermore, because arrow 4 is also an outcome of the object at node A 101, all the influences on the object at node A are indirect influences on both the object at node B 102 and the object at node D 104.

The knowledge tree map greatly simplifies determination of influencing factors on a chain of objects. As a first practical example, assume that a doctor needs to prescribe different types of medications to treat a patient who suffers from high blood pressure, diabetes, and a heart condition. The doctor needs to prescribe three different drugs for the high blood pressure, one drug (insulin) for the diabetes, and three different drugs for the heart condition. In addition, when prescribing insulin for diabetes, the doctor must also take into account the patient's physical activity.

The number of medications and other influences thus complicate the making of an accurate decision for such a patient.

While the doctor's experience and expertise certainly allow him to make a professional diagnosis, applying knowledge tree methodology to such a situation may improve upon the accuracy and reliability of the diagnosis by allowing the doctor to benefit directly from empirical data regarding the situation.

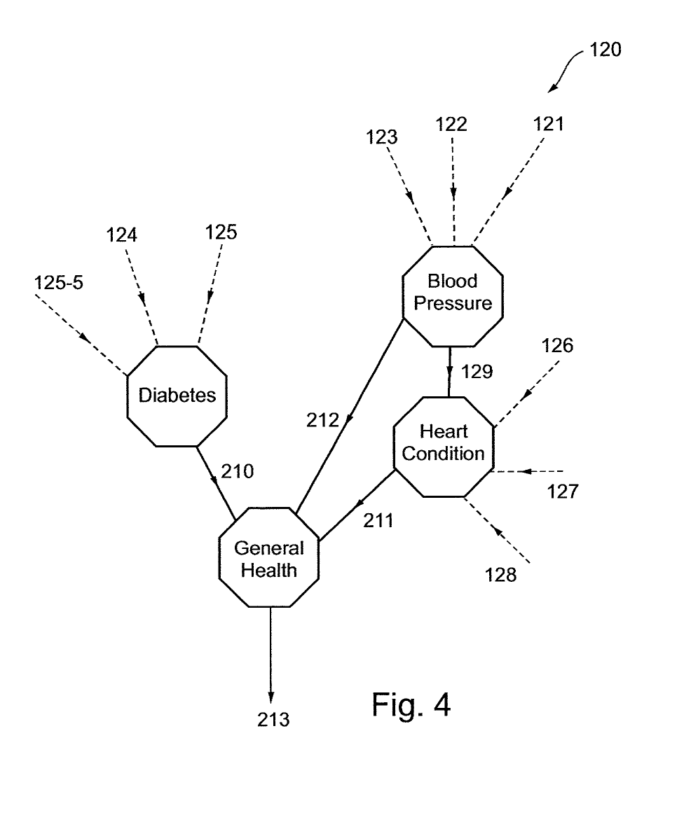

Reference is now made to FIG. 4, which is a simplified knowledge tree map showing how knowledge tree methodology according to an embodiment of the present invention may be applicable to the diagnosis situation referred to above. knowledge tree map 120 comprises arrows 121, 122, and 123 which represent the influence of each of three respective medications for high blood pressure, arrow 124 represents the influence of various amount of insulin, and arrow 125 represents the patient's physical activity on the diabetes. Arrow 125-5 indicates the effect of food intake.

Arrows 126, 127 and 128 represent the influence of each of three respective medications for the heart condition. Arrow 129 represents the influence of the patient's blood pressure on his heart condition; arrow 210 represents the effect of the patient's blood sugar level on his general health; arrow 211 represents the effect which the patient's heart condition has on his general health, and arrow 212 represents the effect of the patient's blood pressure on his general health.

Arrow 213 is the outcome of the patient's general health, which is also the final output of the knowledge tree map 120.

Armed with knowledge tree map 120, the doctor can make a more precise diagnosis for this patient. Existing software tools may use the map to assist in analysis of data relating to the amount and types of drugs and the results which they produce.

In order for a relationship to be verified, the related objects must be subject to quantitative analysis. However, not all objects are readily quantified. Physical activity, for example, is an influence 125 that does not inherently lend itself to being measured, however units of measurement may be devised based on such criteria as the type of activity and the length of time over which it is performed. Similarly, for the influence that the patient's heart condition has on general health, represented by arrow 211, units of measurement may be devised based on the patient's heart history, for example the number and severity of heart attacks, the number of times the patient has been hospitalized for heart problems and the length of stays in hospitals, and so forth. Finally, units of measurement may be devised for categorizing the patient's general health, based on criteria such as the number of annual doctor visits, the number of times a patient has been hospitalized during the past year, length of stays in hospitals, and so forth.

After applying knowledge tree methodology to the patient's situation, the doctor may be able to provide a more precise diagnosis of the physical condition of the patient. Without knowledge tree methodology, the doctor may make his diagnosis based on his experience and expertise. Although the doctor's experience and expertise should not be invalidated, in the face of such a large number of influences, it is impossible to attain the level of accuracy that knowledge tree methodology is able to provide.

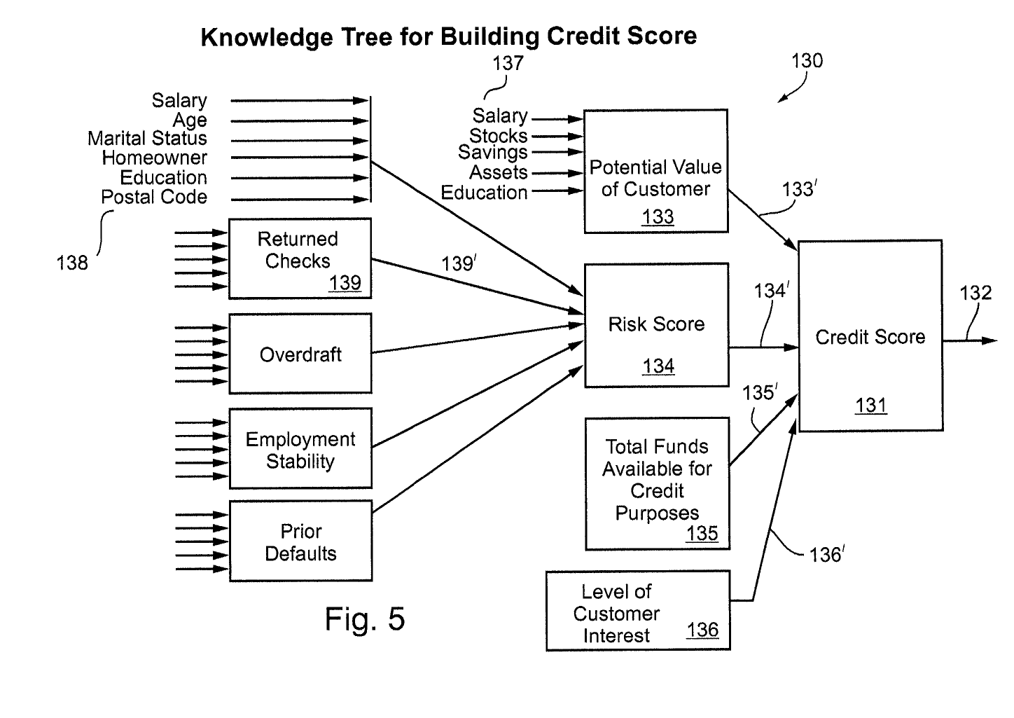

Reference is now made to FIG. 5, which is a simplified diagram showing a knowledge tree map for building a personalized credit score, in accordance with a third preferred embodiment of the present invention.

Knowledge tree map 130 shows objects and relations thereof, which are relevant to automatic (or advanced) processing of a customer application to a bank for a loan. A decision to grant a loan is preferably made according to the outcome 132 of the client's credit score 131 which may be influenced by at least other outcomes 133′-136′ of four objects 133-136 respectively according to an expert such as a financial advisor of the bank.

The outcomes 133′-136′ of each of the respective objects 133-136 are in turn influenced by groups of fundamental influential factors 137, 138 which according to the model are not outcomes of any object, and by outcomes of other objects e.g. outcome 139′ of object 139.

How are objects selected for inclusion in map 130? Firstly because they exist, e.g. as a field in case records the data-base and are a priori related to the problem in hand. Secondly they are provided according to an expert assessment that they should be there, i.e. that they describe factors which influence other (already existing) objects related to the problem at hand.

In some cases data is available for quantitative assessment of the model. In other cases it may be necessary to collect raw data from scratch or to design experiments for the purpose of obtaining data in regard to the objects.

In many cases the list of possible objects for inclusion can be endless. Selection by an expert is arbitrary and may appear incomplete.

A related problem is the validation of assumed relations; only short range or direct relations are validated as such, that is to say relations between influences and an outcome at a single object. The meaning of the term “outcome” may be widened to include a qualitative attribute (a score), which is associated with a respective outcome that results from a unique combination of influences on that object.

Consider for example in FIG. 5 the six influences of group 138 on the outcome 134′ of the “Risk Score” object 134. Suppose that each one of the members of group 138 may possess one of several possibilities. I.e. there are three grades of salary; three categories of age, three categories of martial status, two possibilities as to whether a client is a home owner, three levels of education, and the postal code is also differentiated into three categories. Thus there are 2·3⁵=1458 distinct combinations of inputs to influence the object 134 of “Risk Score”.

Possible outcomes 134′ of “Risk Score” 134 may be divided into e.g. four quantitative risk categories and the quantitative modeling stage may look for a correlation between a combination of influential factors of group 138 and the category of the outcome 134′ of “Risk Score” 134.

Correlation between an influential factor and a category (or score) of an outcome may be accomplished by any known statistical mechanisms e.g. those which are used in data mining such as linear regression, nearest neighbor, clustering, process output empirical modeling (POEM), classification and regression tree (CART), chi-square automatic interaction detector (CHAID) and neural network empirical modeling.

When no correlation (or very little correlation) is observed using the quantitative technique, the alleged influence on the output of the object may be omitted from the resulting quantified KT map.

From the above it may be concluded that validation of a KT structure involves the same procedures as constitute data mining itself. However the ability to direct the data mining means that the knowledge tree methodology allows more accurate results to be achieved and for less processing of data.

As discussed above, in addition to the knowledge-tree methodology being able to determine new influences on a particular object in a chain of events, the connective nature of the knowledge-tree allows an even greater number of indirect influences on the object to be identified and taken into consideration.

The formal procedure of creating a knowledge tree is a multi-step process, which may include the following steps:

(1) Establishing a uniform nomenclature for referring to each of a plurality of objects.

(2) Obtaining expert opinions on relationships between the different objects. The opinions are preferably obtained by distributing questionnaires structured to obtain the relevant information. The questionnaires are preferably based on templates structured to obtain clear and unambiguous information from the experts and in each case to encourage each expert to concentrate on his specific area of expertise. Additionally the templates are preferably structured to allow the different answers from the experts to be compatible so that they can be integrated into a single model.

(3) Unifying each template so that answers given by the experts can be seen to relate to a nomenclature recognizable node, edge, cell or aggregate thereof (contiguous or otherwise).

(4) Building a knowledge tree (using known graph theoretic techniques) from the nomenclature unified templates or using a process map (if a process map exists) and inserting therein new expert-suggested relationships from the ensemble of collected expert suggested relations.

A node that represents an object is termed in knowledge tree methodology an interconnection cell. The interconnection cell is the basic unit from which the knowledge tree map is built. When the outcome of one interconnection cell is an influence on another interconnection cell, such as in the case of arrow 4 in FIG. 3, which joins nodes A 101 and B 102, the two interconnection cells are regarded as being joined together or interconnected, and such interconnectivity between two interconnection cells allows for a global presentation of the knowledge tree map and its use in data mining of large data-bases.

Interconnectivity as described above is useful because the theoretically possible number of interconnection cells can be very large and because each one of them is subjected in turn to an identical data mining software tool framework, which framework analyzes the interconnection cell for purposes of predicting quantitative outcome values at that interconnection cell. For example the objects are subjected to the same analysis advancing from the bottom of the tree to the top, wherein the outcome of one object is an influential factor in the next interconnected object.

Thus, by applying a knowledge tree structure to the data mining process, and only carrying out data mining in respect of relationships indicated on the knowledge tree, a form of data mining referred to hereinbelow as dimension reduced data mining is achieved.

The interconnection cells that build the knowledge tree show between them all the qualitative influences on a particular output characteristic that are believed by the experts to exist, without determining quantitatively how these influences affect the output characteristic. That is, the interconnection cell generated using knowledge tree methodology shows only which factors influence an output characteristic, but not how and to what extent. Other software tools e.g.

POEM determine the quantitative influences in the interconnection cell.

There is thus provided a generalized method for modeling influences giving rise to outputs that involves a first stage of qualitative modeling, and a subsequent stage of directed or dimension reduced data mining that validates and quantifies the relationships qualitatively defined.

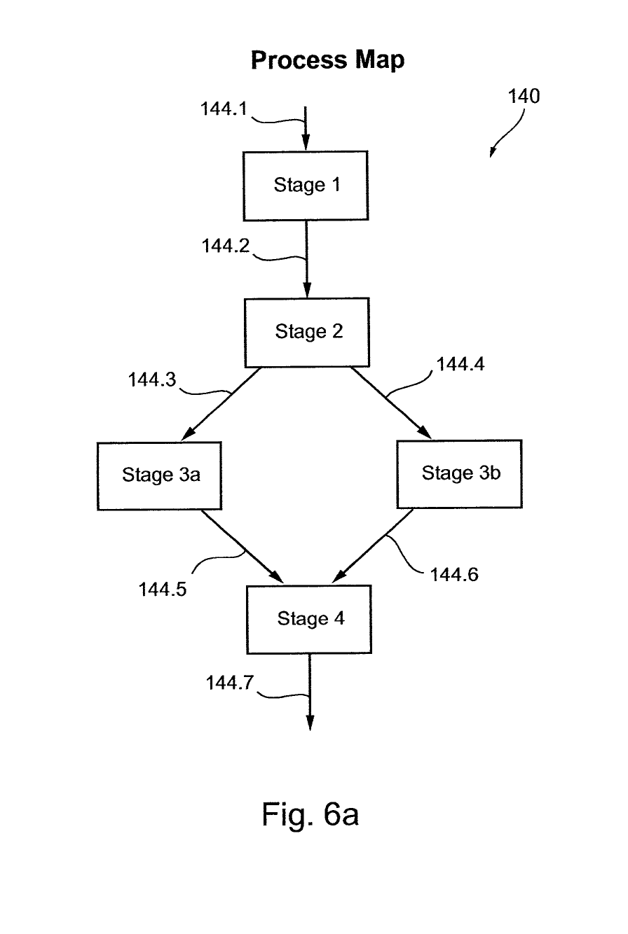

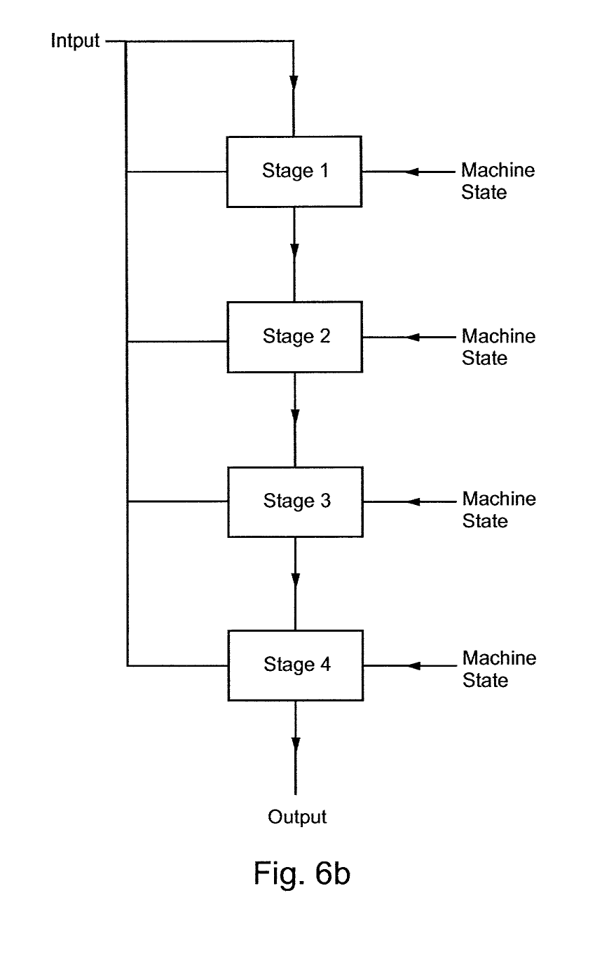

Reference is now made to FIGS. 6A and 6B, which respectively show a standard process map and a functional knowledge tree diagram of the same process in order to illustrate how the present embodiments may be applied to given situations. The process map of FIG. 6A shows a generalized process 140 made up of two stages in series followed two stages in parallel followed by a single stage in series. The two stages in parallel represent a single process stage being carried out by two parallel machines, typically because it is a bottleneck stage which would otherwise slow the process. An initial input and a final output are indicated as well as intermediate outputs. More specifically, arrows labeled 144.2, 144.3, 144.4, 144.5, and 144.6 represent measured output at a given process step that consist measured input to the next process step. Arrow 144.1 represents the initial measured input to the overall process. Arrow 144.7 represents measured output from Stage 4.

A further process stage may be added after Stage 4, in which case the output represented by arrow 144.7 may serve as the input to that next stage. Otherwise arrow 144.7 represents the final output for the process.

Stages 3a and 3b represent parallel stages, which can run simultaneously or in an alternating manner. For example, a process may utilize such stages when an operation carried out at a stage is slower in relation to actions carried out at other stages in the process. In such a case, it is advantageous to break down the slower stage into parallel stages; thereby speeding up process time at that stage. Another example of when parallel stages are used would be for one process that produces two types of output. Such a process may elect which of the different operations are carried out at the “parallel stage”.

FIG. 6B shows the same process in a functional representation. The two diagrams are similar but not identical. Each of the stages is represented in the functional version but it is now no longer of any interest that stage 3 is carried out by two parallel machines. Each stage is influenced by its own input together with the machine state plus optionally environmental factors such as ambient temperature. In the present representation a direct connection is made between the initial input and each individual stage, representing the influence of the raw material quality on each stage of the process. Such a direct connection is purely functional and not a feature of the process map of FIG. 6A.

In general, process control comprises the task of optimizing one or more output characteristics at a given stage in a process. That is, output at a given stage may consist of only one object. However, that object may have any number of characteristics. For example, if we examine baking bread as a process, a finished loaf of bread is considered to be the output of the process. Yet, the bread may be examined for a variety of qualities, such as weight, texture, length, crust hardness, and even taste. Each one of these qualities is an output characteristic. Process control can be applied to the process of baking bread with the goal of optimizing one, some, or all of these qualities. Process control preferably requires a selection to be made as to which output characteristics may be optimized.

In the same way, when examining input at a given process step in the context of process control, the input may be examined for any one of a number of characteristics. For example, a process step may have one input which is a piece of wood. Yet, the wood may be analyzed in terms of its length, width, density, dryness, hardness or other characteristics. Each such characteristic comprises a measurable input. The characteristics according to which process input and output are analyzed are ultimately determined by specific objectives and needs of the process engineer.

Input at a given process step that is received as output from a previous process step is considered to be a type of measurable input. In the context of the present embodiment, a measurable input is any characteristic whose value can be measured but not controlled at the process step in question. Measuring of the input characteristic may be carried out by automated machinery or by a process engineer. Input at a given process step that is received as output from the immediately previous step, is a measurable input at that process step because its value was determined at the immediately previous step and cannot be controlled at the current process step.

Therefore, an input at a process stage such as the input depicted by arrow 144.2 in FIG. 4 may consist of only one item, yet that item can be analyzed in terms of any constituent characteristic. Each constituent input characteristics may therefore be considered to be an independent measurable input. Arrows 144.1, 144.2, 144.3, 144.4, 144.5, and 144.6 in FIG. 6 may each be understood to represent any number of measurable characteristics, regardless of whether there is only one item or entity that is input at the given process step. Likewise, the output represented by arrow 144.7 can be understood to represent any number of measurable outputs, regardless of whether that output consists of only one item or entity.

A difference between traditional process mapping and the functional knowledge tree map used in the present embodiments is that in the functional knowledge tree map, inputs to a particular stage are not restricted to the physical inputs thereto, the state of the machine and the ambient conditions. Rather an attempt is made to list any factor that it is conceived could have an effect on that stage. Thus the initial input may be believed to have a crucial effect on the operation of the third stage, even though it is not a direct input to the third stage. It could not be shown as an input in a process map yet it would and should be shown in a knowledge tree.

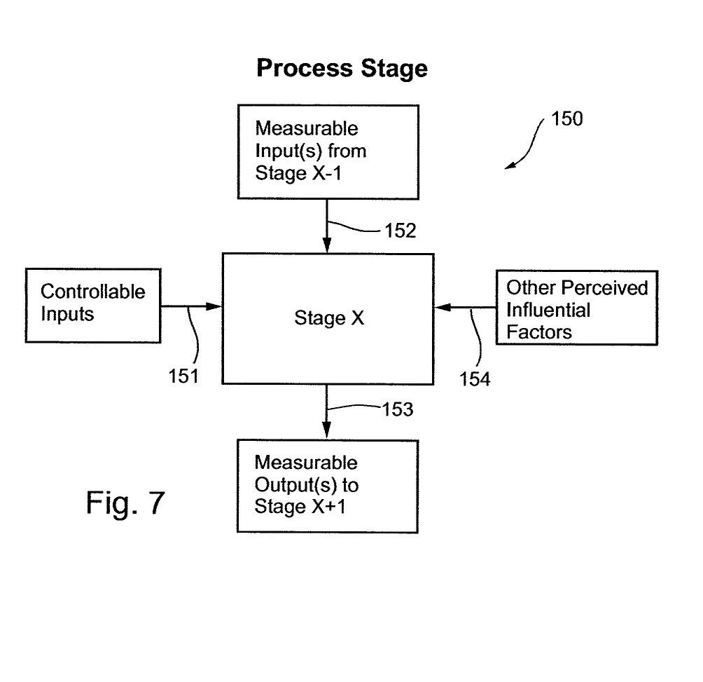

Reference is now made to FIG. 7, which is a simplified diagram of a single process stage. Depicted is a typical stage 150 of the process 140 represented in FIG. 6B. The stage is denoted “stage X”. Like the process steps depicted in FIG. 6, the process step depicted in FIG. 7 receives one or more measurable inputs from the previous process step (arrow 152), and produces one or more measurable outputs that are received by the next process step as one or more measurable inputs (arrow 153).

Arrow 151, to the left of Stage X, depicts one or more controllable inputs for the operation carried out at Stage X. A controllable input is any input that has a direct and obvious influence on output at a given process step, and whose value can be directly controlled by a process engineer or automated machinery carrying out the operation at the given process step. Examples of controllable inputs include for example pressure settings, the speed at which an operation is carried out, or a temperature setting.

In process control in general, it is necessary to monitor the values of controllable and measurable inputs at a given process step, and the values of output characteristics at that process step. Monitored values may then serve as part of the raw data used for process control. The optimization of an output characteristic at a given stage in a process that occurs in process control is carried out by determining values for one or more controllable inputs at that process stage that will yield the desired value of that output characteristic.

As described above, the stage 150 of FIG. 7 is suitable for a conventional process map. However an additional set of factors is added to convert the stage to being a stage of a knowledge tree, that set, marked 154, is a set of other perceived influential factors, and is preferably built by asking a series of experts for their thoughts.

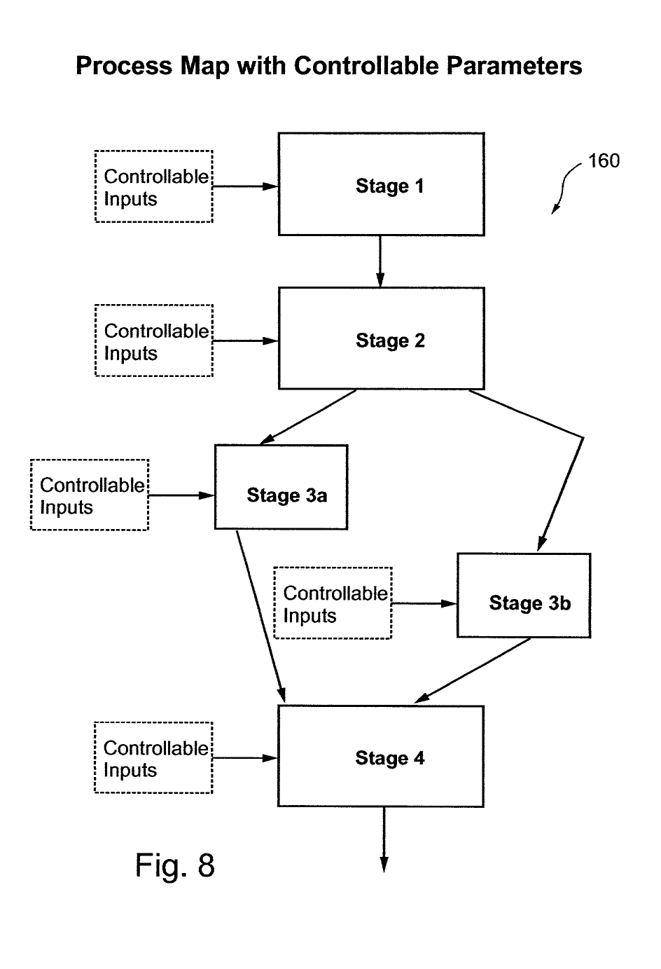

Reference is now made to FIG. 8, which is a simplified process map similar to that of FIG. 6A but additionally showing controllable inputs. The process map 160 comprises the same arrangement of stages as in FIG. 6 but each stage has controllable inputs. The controllable inputs can be set to ensure that the outputs of the respective stages are kept to within a target range.

Interrelationships and Outside Influences

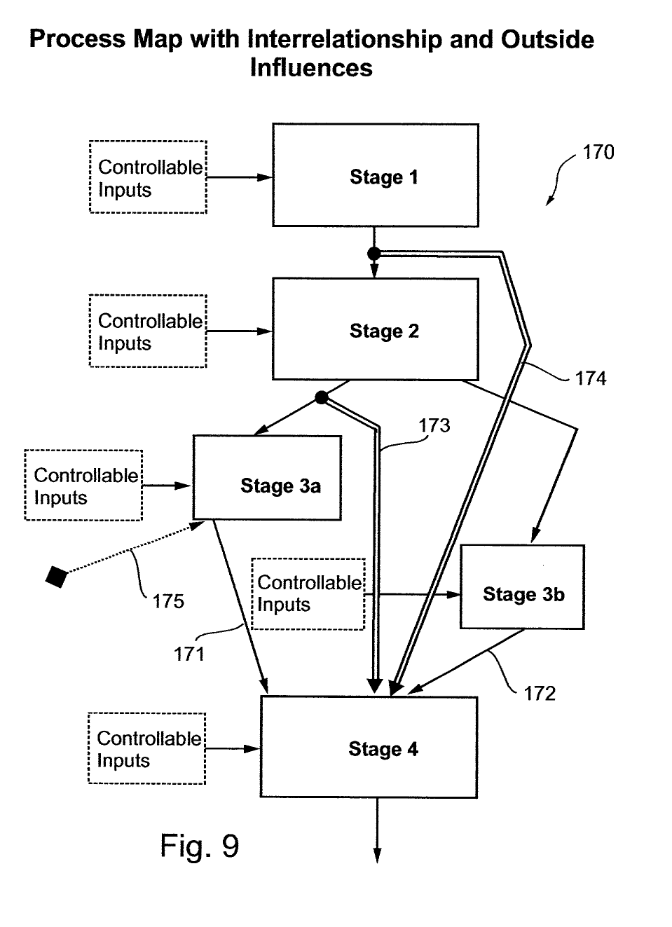

Reference is now made to FIG. 9, which is a simplified diagram showing the same process map again but this time with additional interrelationships. More particularly there is shown a process map 170 which is the process map 60 from FIG. 8, to which arrows are added indicating interrelationships and outside influences at certain process steps. An interrelationship exists when there is alleged or validated information that a particular controllable or measurable input at an earlier Stage X influences in some way a characteristic of the output at a later Stage X+n (where n is any integer greater than 0). In FIG. 9, interrelationships exist between a controllable input at Stage 1 and a characteristic of the output at Stages 3a (arrow 171), between a controllable input at Stage 1 and a characteristic of the output at stage 3b (arrow 172), between a measurable input at Stage 3a and a characteristic of the output at Stage 4 (arrow 173), and between a measurable input at Stage 2 and a characteristic of the output at Stage 4 (arrow 174). When an interrelationship is determined to have a valid influence on an output characteristic at a given stage in a process, that interrelationship is considered to be another type of measurable input at that process stage. The interrelationship may be direct or may be indirect, that is to say working via the intermediary object.

An outside influence exists when there is alleged or validated information that a factor outside of the conventional realm of a process influences a characteristic of an output at a given stage in the process. Examples of outside influences may include for example the room temperature where a process is being carried out, the last maintenance date of process machinery, the day of the week, or the age of a worker.

In FIG. 9, arrow 175 represents an outside influence on an output characteristic at Stage 3a. Outside influences usually comprise measurable inputs, because their values can be measured but in most cases not controlled. In the event that the value of an outside influence can be controlled, such an outside influence may treated as a controllable input. In the context of the present knowledge tree methodology, the relationship that an outside influence has with the output characteristic it influences is also considered to be an interrelationship.

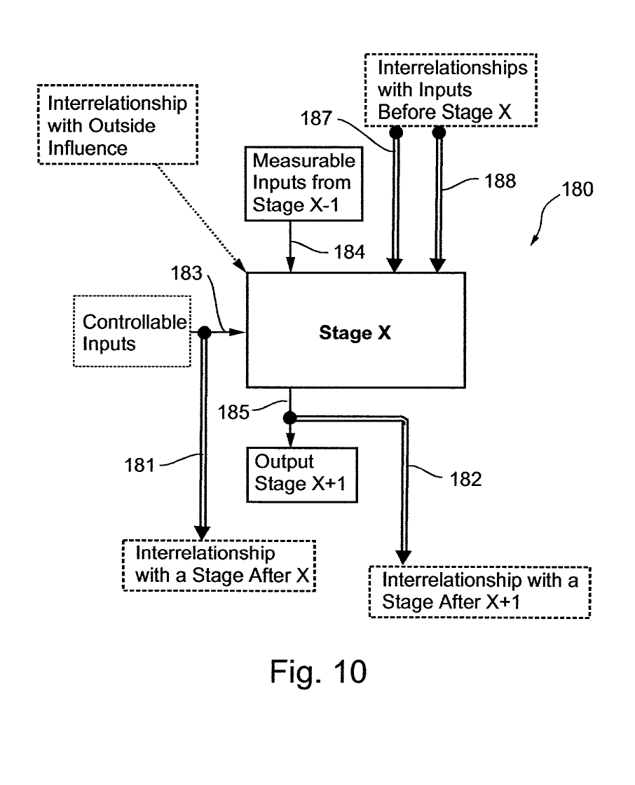

Reference is now made to FIG. 10 which is a simplified diagram showing how a processing stage of any one of FIGS. 7-9 may be extended to allow construction of a knowledge tree map. In FIG. 10, a single process stage 180 incorporates all of the interrelationship types discussed so far. In addition to direct inputs to the system, inputs to earlier stages are considered. Arrow 181 represents an interrelationship between a controllable input at Stage X and an output characteristic at a stage after Stage X; and arrow 182 represents an interrelationship between an output characteristic at Stage X and an output characteristic at a stage after Stage X+1. Arrows 187 and 188 indicate earlier inputs which are believed to affect the operation of stage X.

Standard process control focuses on determining optimal values for controllable inputs at a given process stage in order to improve the quality or quantity of output yield at that stage. The determination is based on either the values of measurable inputs at that stage, the values of one or more output characteristics at that stage from previous runs, or a combination of the two. Such standard control may be understood as a local approach to process control, where corrections are made locally at the process stage under consideration. In FIG. 10, determining optimal values for the controllable inputs labeled 183 at Stage X would thus be based on the values of the measurable inputs from Stage X−1 labeled 184, in order to improve the output 185, or based on the output measured from stage X (labeled 185) in the previous run.

Using the knowledge-tree methodology, there are no a priori notions regarding predominant influences at Stage X. The methodology allows the user to define potential influences on an output characteristic (i.e. to define a potential interrelationship), and then to check whether those interrelationships are in fact valid.

As discussed in detail above, the potential interrelationships to be checked may originate from anywhere in the process, and may even have their sources outside of the conventional realm of the process (i.e. an outside influence). As opposed to the local approach of standard process control, that made possible using knowledge-tree methodology is more of a global approach, in which influences on output may be defined and validated from anywhere within the process.

Validation of such interrelationships may be carried out by means of an algorithm that calculates a correlation coefficient between the input or outside influence that is the source of the interrelationship and the output characteristic that it allegedly influences. Such an algorithm may be any well-known and accepted algorithm for calculating a correlation coefficient between two data sets, or any algorithm which produces a substantially equivalent result, and examples have been given above. A high correlation coefficient (i.e. a number with an absolute value close to 1 on the scale of 0 to 1) means that the interrelationship is valid and may be considered when implementing process control. Likewise, a low correlation coefficient means that the interrelationship is not valid or not particularly important. It is desirable in process control to give priority to considering the most valid relationships to process stages. The choice of how many, and which relationships, is partially determined by computational capacity, partially determined by data availability and the final decision may be one in which expert input is desirable. An advantage of the present invention is that the results of the quantization process are available in the same tree format as the initial qualitative model, and the quantitative values may be added as coefficients to the relevant connections, to present a model which is easy to understand. Thus user intervention at the quantitative stage is simple and straightforward.

The Interconnection Cell in Process Control

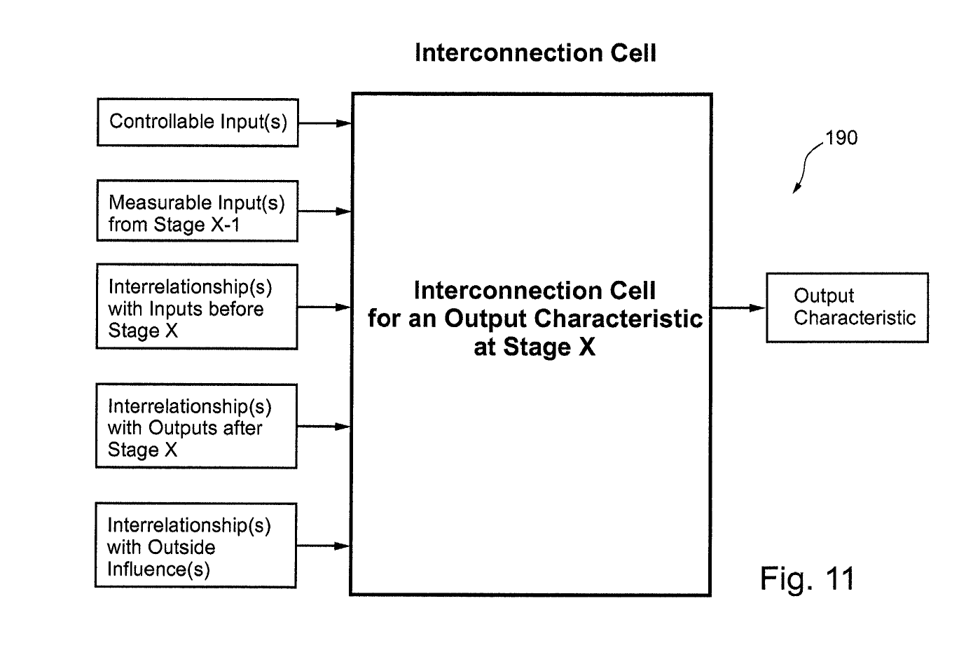

Reference is now made to FIG. 11, which is a simplified representation of an interconnection cell 190 for a particular aspect of the output at Stage X. Included in amongst the valid influences on the given output characteristic at Stage X are also output characteristics at process steps after Stage X that are actually influenced by (rather than influencing) the output characteristic at Stage X. For example, assuming that knowledge-tree based methodology is used to determine all the significant influences on an output characteristic OCₓ at Stage X, then knowing whether OCₓ influences other output characteristics at process steps after Stage X can be useful in determining an optimal target value for OCₓ. Thus, a feature, Interrelationship(s) with outputs after Stage X is included in the interconnection cell as an influence on the output characteristic.

In the context of process control, a given interconnection cell may represent only the various influences on one particular characteristic of the output of a given process step. The cell need not represent the process step per se. As mentioned previously, the output at a given process step may be analyzed according to any of its possible characteristics, and thus each output characteristic may be represented by its own interconnection cell.

Furthermore, one interconnection cell does not by definition have to correspond to only one process step. In the context of process control, any group of sequential process steps can be combined into a single process module. In such a case an interconnection cell may be defined as corresponding to a process module, where all the controllable and measurable inputs of the interconnection cell provide the controllable and measurable inputs for all the process steps in the module and the output characteristic of the interconnection cell is an output characteristic of the final step in the module.

As described above, the validation and quantization of relationships has been described together, in that a single data mining process is used to obtain values which quantized the relationships, those quantization values then being used to validate the relationships and discard the relationships shown to be unimportant. However, the very act of discarding relationships alters the tree from that for which the quantities were calculated so that it is more strictly accurate to carry out two separate stages of validation and quantization. Thus, after interrelationships have been defined by the user and validated by knowledge tree, those interrelationships are used by other software tools, for example POEM, to determine the quantitative relationship between the given output characteristic and the factors that have been determined to influence that output characteristic. The ability to apply knowledge-tree methodology in the manner described presents the original raw data with quantitative relationships between data of a given output characteristic and data of the various types of inputs and shows interrelationships that influence that output characteristic. Without the use of knowledge-tree methodology, quantitative cause and effect relationships between the output characteristic and those interrelationships determined to affect it may have remained otherwise undetected.

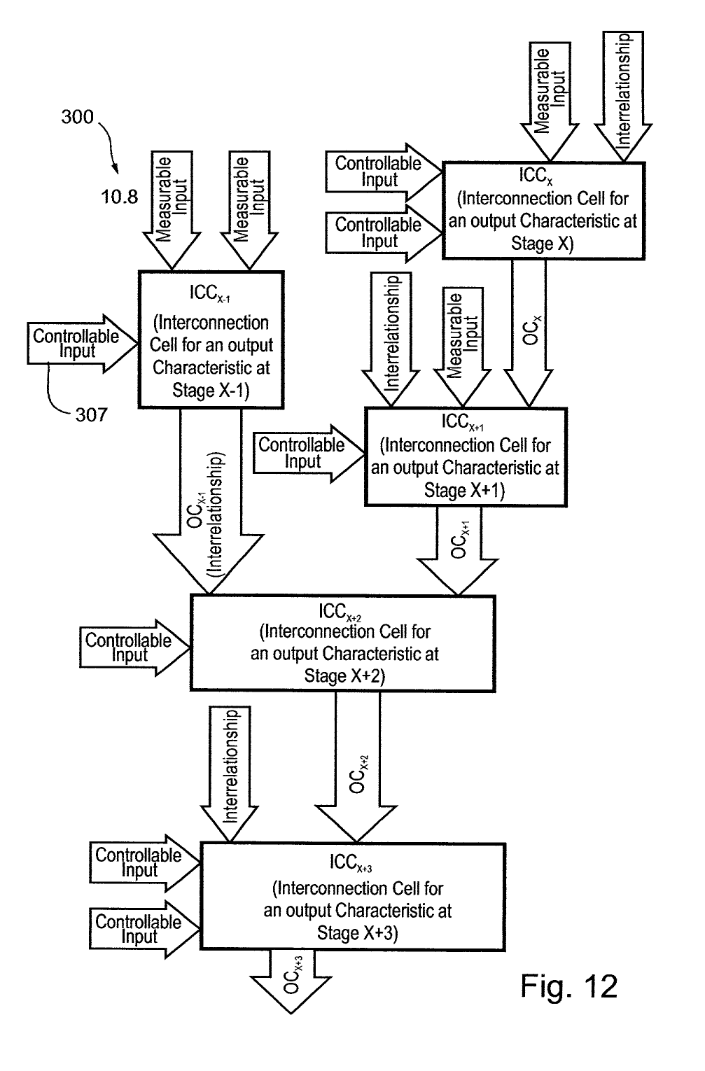

In preferred embodiments, a group of interconnection cells may be joined together to form a knowledge tree. In the context of process control, two interconnection cells are joined together when the output characteristic of one interconnection cell is a measurable input to another interconnection cell. For example, two interconnection cells labeled ICCₓ and ICCₓ₊₁ are depicted in FIG. 12 to which reference is now made. ICCₓ is an interconnection cell for an output characteristic labeled OCₓ at Stage X in a given process, and ICCₓ₊₁ is an interconnection cell for an output characteristic OCₓ₊₁ at Stage X+1 in that same given process. The output characteristic OCₓ at interconnection cell ICCₓ is also a measurable input at interconnection cell ICCₓ₊₁, and these two interconnection cells are thus considered to be joined together.

It follows that for any given process, the number of possible knowledge-tree configurations is dependent upon the number of process steps and the possible output characteristics at each step. Furthermore, it is noted that a given knowledge tree configuration for a process is not in itself a process map. A process map depicts all the process steps and the flow of input and output from any given step in the process to the next step in the process. A knowledge tree for a given process by contrast focuses only on those output characteristics deemed important by the process engineer for purposes of process control. Further, knowledge tree mapping of interconnection cells need not necessarily correspond to all the steps in a process, nor is this mapping of interconnection cells bound to the sequential order of the process.

Reference is now made to FIG. 12, which is a simplified diagram showing an arrangement of interconnection cells of the kind shown in FIG. 11 arranged as a knowledge tree map 300 as opposed to a process map. In FIG. 12, an interrelationship exists between output characteristic OCₓ₋₁ at interconnection cell ICCₓ₋₁ and output characteristic OCₓ₊₂ at interconnection cell ICCₓ₊₂. Interconnection cell ICCₓ₋₁ is shown as directly preceding interconnection cell ICCₓ₊₂, even though the process steps that these two interconnection cells correspond to are not adjacent.

The knowledge tree map may be used in troubleshooting process output. For example, referring again to FIG. 12 in which a section of a knowledge tree map 300 is shown, it may be assumed that there is a specification range for output characteristic OCₓ₊₃ at interconnection cell ICCₓ₊₃, and that in recent process runs the values received for OCₓ₊₃ have been out of that specification range. According to standard methods of process control, in order to bring the value for OCₓ₊₃ back into the specification range, corrections should be made to one or both of the controllable inputs at the process step corresponding to ICCₓ₊₃. According to the knowledge tree map in FIG. 10, OCₓ₊₂ is the output characteristic for interconnection cell ICCₓ₊₂ and is a measurable input for interconnection cell ICCₓ₊₃. Therefore, changes in the value of OCₓ₊₂ will affect the value of OCₓ₊₃. Of course, OCₓ₊₂ is a measurable input and its value cannot be directly controlled. However, the knowledge tree may reveal various possible means of indirectly changing the value of OCₓ₊₂. The most obvious is to affect a change on the value of OCₓ₊₂ with the controllable input labeled at interconnection cell ICCₓ₊₂.

Another way in which the knowledge tree may be used to restore the output value is by controlling the controllable inputs to ICCₓ₊₃ in the light of the measured values of input OCₓ₊₂ and the interrelationship input. That is to say the quantization process may have been able to provide information as to what are the best values of the controllable inputs to select in the light of the current measurable input values.

Another possible means of affecting a change on OCₓ₊₂, is to try to affect a change on the output characteristic OCₓ₋₁, which, according to the knowledge tree has been determined to have an interrelationship with output characteristic OCₓ₊₂ at interconnection cell ICCₓ₊₂. OCₓ₋₁ is the output characteristic for the process step X−1, which is three steps prior to process step X+2. Yet, the knowledge tree may show that there is an interrelationship between OCₓ₋₁ and OCₓ₊₂. Therefore, affecting a change on OCₓ₋₁ will in turn affect OCₓ₊₂, which in turn will affect OCₓ₊₃. Again, there are various options for changing the value of OCₓ₋₁, the most direct being to adjust the value of the controllable input labeled 307 at interconnection cell ICCₓ₋₁. Furthermore, depending on the actual number of process steps preceding step X−1, there may be a wide variety of even more options.

Thus, by using knowledge tree methodology and backtracking through the knowledge tree map according to input/output connections and interrelationships, it is possible to locate influences on process output that may not have been detectable according to standard means of process control. Often, backtracking in the above manner need not be the most effective means of improving output characteristic values; but in many circumstances, detection of new influences, heretofore unknown, may allow for easier and/or more cost-efficient means of improving an output characteristic.

After modeling the cell, appropriate input combinations yielding optimal outputs may be discovered. The combinations give a recipe for optimal manufacturing procedure using the tool.

The knowledge tree methodology described above thus provides an enabling tool which can be applied to a wide range of circumstances. The tool allows for the discovery of new and valuable knowledge and techniques by directed data mining of data sets associated with processes. The processes are first broken down into aggregates of various elements, each element characterized by a set of inputs and, generally, a single output. The processes, characterized in the above manner, are graphically symbolized as a knowledge tree. The method comprises a stage of qualitative modeling of the interrelations between the aggregates thus represented, which stage is preferably guided and determined by input of a domain expert to the problem at hand.

A stage of data mining is then directed by the knowledge tree map. Use of the map allows data to be considered only if it is relevant to the model desired. This data acquisition is aimed at two things, first of all validating relationships believed to be important by the expert and secondly determining actual quantitative relationships between the interconnection cells of the knowledge tree. As mentioned above, whilst the two aims are generally provided in a single data mining stage, for greater accuracy they could be provided as two separate operations, the final quantitative relationships that are entered into the model being obtained using the fully validated model to which they are to apply.

As the relationships are relevant on a qualitative level, the quantitative analysis

(1) gives significance to trends in the relationships,

(2) is able to detect deviations from the trends, and

(3) gives indications as to means of attaining particular goals in circumstances of deviations from trends.

The latter two items of the above list represent both potentially valuable knowledge and valuable techniques or processes, which may have technical innovation and feasibility.

The knowledge tree following quantitative modeling comprises an empirical model of the process being analyzed. The knowledge tree creates a global system model from the local cell quantitative models. It thus provides a means of testing hypotheses and validating assumptions according to actual data. Viewed in this way the KT serves a method, system and tool of discovery, which for example can be a new procedure for carrying out a manufacturing process in a more efficient or economic way, or a new medical procedure related to drug treatment. A number of examples follow:

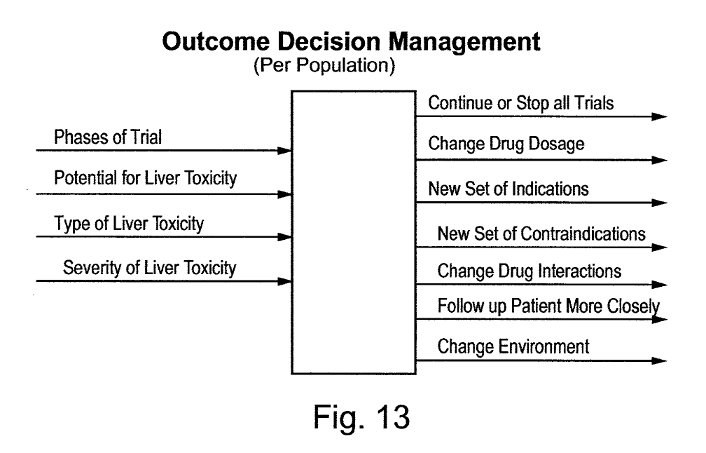

Reference is now made to FIG. 13, which is a simplified schematic diagram showing a list of influences and outcomes relevant to evaluation of liver toxicity for a given medical treatment.

Thus, a pharmaceutical company needs to decide what actions are appropriate for the optimal success of a specific new drug. We assume that the drug is progressing through clinical trials and in some of the patients early signs of liver toxicity have begun to appear.

From a business point of view the circumstances are awkward. It may be necessary to halt the clinical trials and lose the money that has been invested in the drug (top right in FIG. 13). Other options, for example changing the drug dosage or indications, may imply that the pharmaceutical company has to invest additional millions of dollars to prove that the new levels etc. are valid. It is also possible that changes to the patient environment, such as giving the patient a specific diet or exercise will improve overall effectiveness of the drug. The best scenario, is finding that the signs of liver disease are not dangerous in any way and the knowledge tree methodology enables the trial to follow-up the patients more closely to aid in making the correct decision.

The first stage in applying knowledge tree methodology is to analyze and determine the variables that may affect the decision, which is to say to look for inputs to the tree object. As previously said, the severity of the liver dysfunction is a major element. The type of liver toxicity is also important, some types are dose-related and therefore, if we lower the dose we will be able to eliminate the liver side effects. Our business decision may also be affected by stage reached in trial. The later the stage, the more the pharmaceutical company has invested in the drug and the fewer later complications may be expected. If the drug is in a relatively early stage, more side effects may be expected later on and therefore it may seem wiser to stop using the specific drug.

An important input is the potential for liver severe toxicity. Sometimes one s willing to suffer some liver dysfunction as long as one obtains the required therapeutic effects. This is particularly so in the case of treatments for life threatening diseases such as cancer and AIDS. In such circumstances, the lethal potential of the disease outweighs moderate liver side effects of the drug.

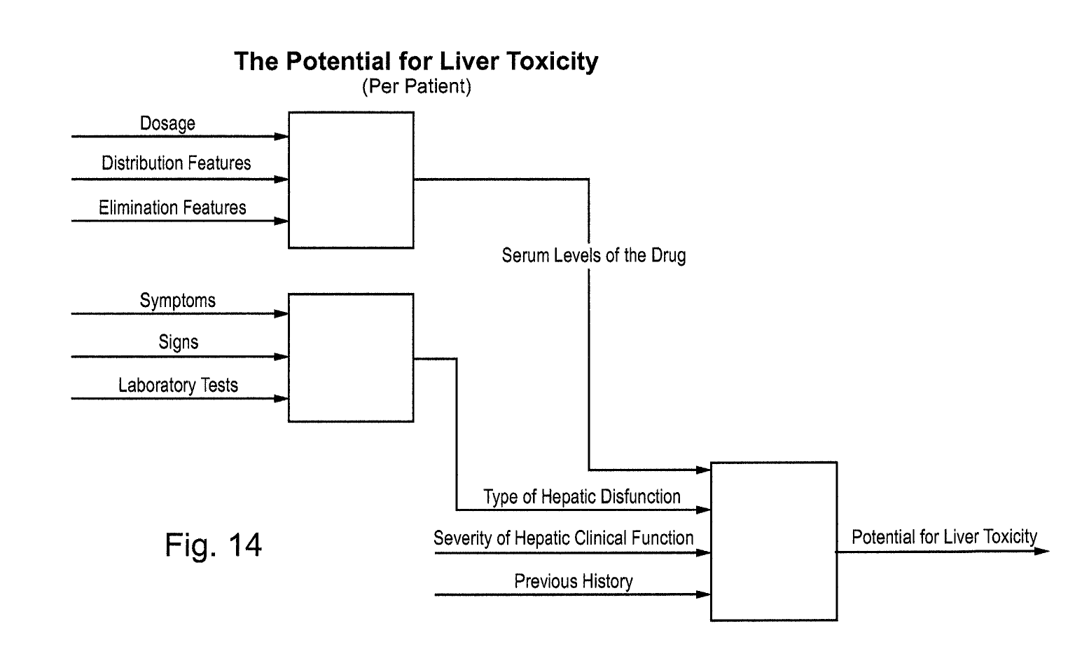

Reference is now made to FIG. 14, which shows a knowledge tree depicting the liver toxicity situation of FIG. 13, but from the point of view of the individual patient. The tree may be used to predict the likelihood and magnitude of liver toxicity on an individual patient.

In FIG. 14, three objects are defined, two initial objects in parallel and a third object in series with the first two. Relevant inputs and outputs are defined in each case.

The tree of FIG. 14 serves as a tool to analyze an individual patient. Accumulation of information from a large number of patients may then form the basis for a balanced decision about the future of the drug.

When dealing with a single patient, the potential for liver toxicity can be estimated from the type of liver dysfunction that was found. They are numerous, perhaps hundreds, of such situations causing liver problems.

The liver is an important organ dedicated to the most intensive biochemical functions of the body. The liver processes the results of our digestion processes. Many of the materials that enter the body are activated or deactivated within the liver. Some of these materials are excreted from the body by the liver through the bile to the stool (this is what gives the stool it's color).

If any one of the functions of the liver are injured in some way, undesirable materials may accumulate, initially in the liver itself. Damage to the liver cells may ensue giving rise to some dysfunction of the liver. The physician checks for symptoms, signs and laboratory tests pointing to a specific type of hepatic dysfunction—but the computer may be able to check more thoroughly using a much larger knowledge base. The computer's superiority over the physician is especially true when dealing with very rare drug effects occurring in just a very small number of patients.

The type of hepatic dysfunction is one of four inputs required to estimate the potential for liver toxicity. Another important input is the serum level of the drug. Many chemicals, when given in high enough dose, will cause injury to the liver. However, some drugs may cause an allergic reaction in which minute doses may completely destroy the liver. The combination of very low serum levels of the drug combined with extreme severity, point to such an allergy. It is also necessary to take into account the condition of the liver before the drug was given. Previous history of liver dysfunction (such as cystic fibrosis), may serve as a warning in regard to the potential for liver toxicity.

The knowledge tree itself is created by using existing knowledge. Experts cannot insert into the model more than they know or at least suspect. The existing knowledge is built into the knowledge tree by professional experts with know how in the specific discipline. In medicine—physicians, pharmacologists and nurses would be the type of people to create the knowledge tree. Working together they are able to create an integrated overview of the problem at hand, including the necessary parameters and their hierarchy from their respective different viewpoints.

The knowledge tree does not therefore comprise new information in itself; it is rather a way of organizing information in a more structural design.

After the knowledge tree has been created, data driven or other models yield a model of the entire process/problem. At this point, new knowledge may be found and validated much faster.

For example, returning to FIG. 14, the knowledge tree shows the potential for liver toxicity at the patient level.

Using the knowledge tree, and moving from right to left, we may infer that modifying the dosage may prevent liver toxicity. We may even determine an exact dosing method. For instance, the patient may have been prescribed 2 tablets, twice per day, but using the KT we may be able to determine that 1 tablet 4 times a day will prevent the side effects. Such a new discovered fact or rule is valuable.

The more detailed the KT, the greater is the potential for “new” knowledge discovery.

In fact, when the knowledge tree is sophisticated enough it begins to comprise new knowledge of its own. Specific relationships may be found using the new KT, and some old relationships may be canceled as being insignificant.

Using the KT methodology, organizations may analyze clinical data in an organized and systematic fashion.

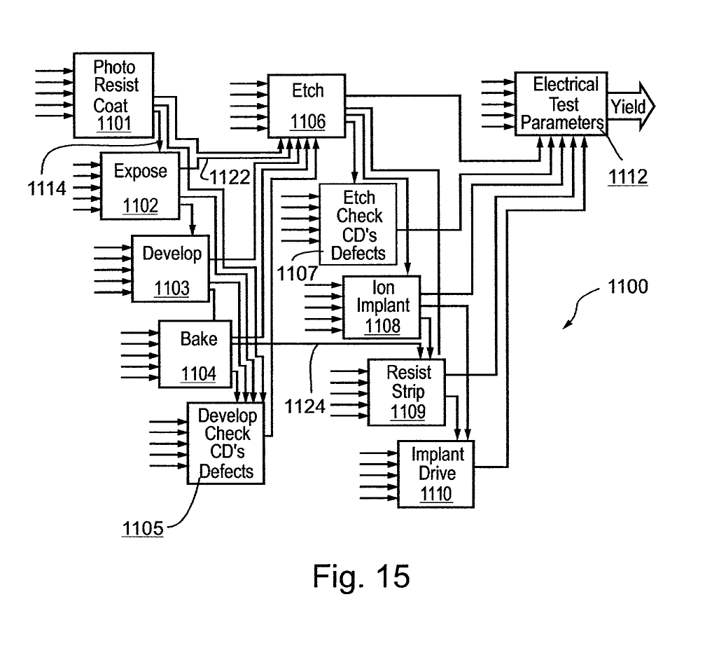

Reference is now made to FIG. 15, which is a simplified diagram of a knowledge tree map directed to a semiconductor manufacturing process. In the map of FIG. 15, eleven process steps 1101-1112 are each shown with interconnection and external factors being indicated. A stage of testing electrical parameters 1112 constitutes the final stage of the manufacturing process.

The knowledge tree map of FIG. 15 shows a process 1100 comprising a number of process steps 1101-1112, represented as an arrangement of interconnection cells, the cells relating to actual steps in the manufacturing process as known in the prevailing microelectronic manufacturing art.

The knowledge tree map shows interconnections and external factors as arrows, as described in the following:

Some of the arrows are linkages between interconnection cells, and these are indicative of a second stage being performed on a wafer whose state is an output of the preceding stage.

For example, linkage 1114 interconnecting cells 1101 and 1102 represents the straight forward transition between a first and a second manufacturing step.

Linkages further normally include relationships based upon proven casual relationships. Proven casual relationships are defined as those relationships for which there is empirical evidence, such that changes in the parameter or metric of the source or input interconnection cell produce significant changes in the output of the destination interconnection cell.

Linkages inserted to the model may further include those based upon alleged causal relationships. These relationships are usually, but not limited to those relationships suggested by professional experts in the manufacturing process or some portion thereof.

An example of such a relationship is demonstrated by arrow 1124 which is seen to connect interconnection cells “Bake” 1104 and “Resist Strip” 1109.

Linkages of this type, which are not commonly anticipated, may be tentatively established and added to the knowledge tree on any basis whatever; real, imagined, supposed or otherwise.

As discussed above, the links inserted at the model building stage are verified at the quantization stage.

There is thus provided a system that allows study of a system or process or the like, that allows for expert input into the system, and that provides a model based on human and automatic or advanced processing that can be used in study of the system or in automatic or advanced decision making.

In a preferred embodiment of the present invention, an unlimiting example of the abovementioned chemical process is batch chemical production. Batch chemical applications involve numerous variables and an endless combination of those variables. Each batch of raw material has its own structure and properties, and each process unit state is at a different life stage. A batch process is performed in six basic stages: preparation, premixes, reactors, temporary storage, product separation and product storage. At each stage, one of a multiple process units is selected. This means that in order for a recipe to be accurate, it must be based on the current process unit state, the previous process unit state as well as the raw material parameters.

Before the control set-up and recipe can be determined, the Knowledge Tree creates a logical map, which portrays the relationship of each component or stage in the batch reactor process. A knowledge tree maps some of the energy profile relationships. In an actual map, the relationships between all factors and variables are taken into account, in order to produce the desired outcome.

Often the relationships between factors and variables only become apparent when they are looked at as logical processes. This logical map serves as a guide for creating individual models for each outcome.

Each Knowledge Tree cell distinguishes between three different types of inputs that affect the outcome. Setup variables, incoming material measurements, and process unit state properties. Setup variables, such as steam quantity and the profile are adjustable. Though these parameters have been traditionally controlled to keep the product within specification, this method has not been adequately successful. It does not account for the disturbances introduced by the incoming material properties or the process unit properties. These additional inputs must be taken into account in order to avoid variability, which is the major cause of an off-spec product.

According to the teachings of this invention Knowledge Tree technology is used to compensate for variations and to assign an optimal set-up to the machine—in real-time. This optimal set-up takes into account the machine and incoming material state to truly compensate for all variations. The result is an outcome that achieves an optimal target with minimized variation and greater yield.

In a further embodiment of the present invention, the process of lens polishing is hereinafter described as an example of Knowledge Tree enablement. The following issues are examples of tasks facing the lens polishing industry: reducing grinding and polishing time, minimizing the amount of scrap and rework and aligning the upper and lower axis of the lens and the grinding tool. When trying to obtain optical surfaces that are within λ/20 regularity, small effects can have major influences. The process becomes further complicated with aspheric lenses because the local curvature varies as a function of the radial position. As a primary stage in an Advanced (or automatic) Process Control for the entire process, a Knowledge Tree is first built. The Knowledge Tree creates a logical map that portrays the relationship between each component or stage in the lens production process. Each of these stages is portrayed as a separate cell. Relationships between all factors and variables are taken into account, in order to produce the desired outcome. Often the relationships between factors and variables only become apparent when they are viewed as part of the knowledge tree. This logical map serves as a guide for creating individual models for each outcome.

A Knowledge Tree cell distinguishes between three different types of inputs that affect the outcome. Setup variables, incoming material measurements, and machine state properties. Setup variables, such as head speed and pressure are adjustable. Though these parameters have been traditionally used to keep the product within specification, this method has not been adequately successful. It does not account for the disturbances introduced by the incoming material properties and the machine properties. These additional inputs must be taken into account in order to avoid variability, which is the major cause of an off-spec product.

The technological solution as described by this embodiment in the lens polishing industry offers a proprietary technology to compensate for variations and assign an optimal set-up to the machine—in real-time. This set-up takes into account the machine and incoming material state. The result is an outcome that achieves an optimal target with minimized variation and greater yield.

An additional embodiment of the present invention is in the food powder production process. As described in the abovementioned examples, factors rarely taken into account in food powder production such as raw materials' structure and properties, and the plant, evaporator and spray dryer. The following issues are examples of problems that must be overcome in order to cut costs while at the same time maintaining the highest quality standards: required adherence to the strict specifications regulated by the FDA or similar government agencies. Powder produced that is out of spec (e.g. low solubility) is often discarded, imprecise variable and parameter measurements resulting in a poor quality yield and loss of material during the evaporation stage and excessive energy consumption when optimal settings are not used. The first stage in the Advanced (or automatic) Process Control (APC), the milk powder production process is broken down into its individual stages such as evaporation and spray drying. At each of these stages, the APC technology determines an individualized recipe based on the particular state conditions (the incoming material state and machine state at that moment).

Before a recipe can be determined, the Knowledge Tree creates a logical map, with each component or stage in the powder production process. Each stage is portrayed as a separate cell and is represented in the diagram by a blue square. This logical map later serves as a guide for creating individual models for each outcome.

The Knowledge Tree shows the relationship between the two process cells by depicting the outcome of evaporation as the input for spray drying.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

While the invention has been described with respect to a limited number of embodiments, it will be appreciated that many variations, modifications and other applications of the invention may be made.

What is claimed is:

1. Apparatus for constructing a quantifiable model, the apparatus comprising:
an object definer for converting user input into at least one cell having inputs and outputs,
a relationship definer for converting user input into relationships associated with said cells such that each said relationships is associatable with said cells via one of said inputs and outputs,
a quantifier for analyzing a data set to be modeled to assign quantitative values to said relationships and to associate said quantitative values with said associated inputs and outputs, thereby to generate a quantitative model.

2. Apparatus according to claim 1, further comprising a verifier for verifying at least one relationship, said verifier comprising determination functionality for determining whether said associated quantitative value is above a threshold value and deletion functionality for deleting said associated input or output if said quantitative value is below said threshold value.

3. Apparatus according to claim 1, wherein said quantifier comprises a statistical data miner.

4. Apparatus according to claim 1, wherein said quantifier comprises any one of a group including: linear regression, nearest neighbor, clustering, process output empirical modeling (POEM), classification and regression tree (CART), chi-square automatic interaction detector (CHAID) and neural network empirical modeling.

5. Apparatus according to claim 1, wherein said data is a predetermined empirical data set.

6. Apparatus according to claim 1, wherein said data is a preobtained empirical data set describing any one of a group comprising a biological process, sociological process, a psychological process, a chemical process, a physical process and a manufacturing process.

7. Apparatus according to claim 1, wherein said quantitative model is a predictive model usable for decision making.

8. Apparatus for studying a process having an associated empirical data set, the apparatus comprising:
an object definer for converting user input into at least one cell having inputs and outputs,
a relationship definer for converting user input into relationships associated with said cells such that each said relationships is associatable with said cells via one of said inputs and outputs,
a quantifier for analyzing said associated empirical data set to assign quantitative values to said relationships and to associate said quantitative values with said associated inputs and outputs, thereby to generate a quantitative model.

9. Apparatus according to claim 8, further comprising a verifier for verifying at least one relationship, said verifier comprising determination functionality for determining whether said associated quantitative value is above a threshold value and deletion functionality for deleting said associated input or output if said quantitative value is below said threshold value.

10. Apparatus according to claim 8, wherein said quantifier comprises a statistical data miner.

11. Apparatus according to claim 8, wherein said quantifier comprises functionality for any one of a group including: linear regression, nearest neighbor, clustering, process output empirical modeling (POEM), classification and regression tree (CART), chi-square automatic interaction detector (CHAID) and neural network empirical modeling.

12. Apparatus according to claim 8, wherein said data is a predetermined empirical data set of said process.

13. Apparatus according to claim 8, wherein said process comprises any one of a group comprising a biological process, sociological process, a psychological process, a chemical process, a physical process and a manufacturing process.

14. Apparatus according to claim 8, wherein said quantitative model is a predictive model usable for decision making.

15. Apparatus for constructing a predictive model for a process, the apparatus comprising:
an object definer for converting user input into at least one cell having inputs and outputs,
a relationship definer for converting user input into relationships associated with said cells such that each said relationships is associatable with said cells via one of said inputs and outputs,
a quantifier for analyzing a data set relating to said process to be modeled to assign quantitative values to said relationships and to associate said quantitative values with said associated inputs and outputs, thereby to generate a model predictive of said process.

16. Apparatus according to claim 15, further comprising a verifier for verifying at least one relationship, said verifier comprising determination functionality for determining whether said associated quantitative value is above a threshold value and deletion functionality for deleting said associated input or output if said quantitative value is below said threshold value.

17. Apparatus according to claim 15, wherein said quantifier comprises a statistical data miner.

18. Apparatus according to claim 15, wherein said quantifier comprises functionality for any one of a group including: linear regression, nearest neighbor, clustering, process output empirical modeling (POEM), classification and regression tree (CART), chi-square automatic interaction detector (CHAID) and neural network empirical modeling.

19. Apparatus according to claim 15, wherein said data is a predetermined empirical data set of said process.

20. Apparatus according to claim 15, wherein said process comprises any one of a group comprising a biological process, sociological process, a psychological process, a chemical process, a physical process and a manufacturing process.

21. Apparatus according to claim 15, further comprising an automatic decision maker for using said predictive model together with state readings of said process to make feed forward decisions to control said process.

22. Apparatus according to claim 15, wherein said quantitative model is a predictive model usable for decision making.

23. Apparatus for reduced dimension data mining comprising:
an object definer for converting user input into at least one cell having inputs and outputs,
a relationship definer for converting user input into relationships associated with said cells such that each said relationships is associatable with said cells via one of said inputs and outputs,
a quantifier for analyzing a data set relating to a process to be modeled comprising a selective data finder to find data items associated with said relationships and ignore data items not related to said relationships, said quantifier being operable to use said found data to assign quantitative values to said relationships and to associate said quantitative values with said associated inputs and outputs.

24. Apparatus according to claim 23, further comprising a verifier for verifying at least one relationship, said verifier comprising determination functionality for determining whether said associated quantitative value is above a threshold value and deletion functionality for deleting said associated input or output if said quantitative value is below said threshold value.

25. Apparatus according to claim 23, wherein said quantifier comprises a statistical data miner.

26. Apparatus according to claim 23, wherein said quantifier comprises functionality for any one of a group including: linear regression, nearest neighbor, clustering, process output empirical modeling (POEM), classification and regression tree (CART), chi-square automatic interaction detector (CHAID) and neural network empirical modeling.

27. Apparatus according to claim 23, wherein said data is a predetermined empirical data set of said process.

28. Apparatus according to claim 23, wherein said process comprises any one of a group comprising a biological process, sociological process, a psychological process, a chemical process, a physical process and a manufacturing process.

29. A method of constructing a quantifiable model, comprising:
converting user input into at least one cell having inputs and outputs,
converting user input into relationships associated with said cells such that each said relationship is associated with said cells via one of said inputs and outputs,
analyzing a data set to be modeled to assign quantitative values to said relationships and to associate said quantitative values with said associated inputs and outputs, thereby to generate a quantitative model.

30. A method for reduced dimension data mining comprising:
converting user input into at least one cell having inputs and outputs,
converting user input into relationships associated with said cells such that each said relationship is associated with said cells via one of said inputs and outputs,
analyzing a data set relating to a process to be modeled comprising a finding data items associated with said relationships and ignoring data items not related to said relationships, and using said found data to assign quantitative values to said relationships and to associate said quantitative values with said associated inputs and outputs.

31. A knowledge engineering tool for verifying an alleged relationship pattern within a plurality of objects, the tool comprising
a graphical object representation comprising a graphical symbolization of the objects and assumed interrelationships, said graphical symbolization including a plurality of interconnection cells each representing one of said objects, and inputs and outputs associated therewith, each qualitatively representing an alleged relationship, and
a quantifier for analyzing a data set of said objects to assign quantitative values to said relationships and to associate said quantitative values with said alleged relationships, thereby to verify said alleged relationships.

32. The knowledge engineering tool as in claim 31, wherein said quantifier comprises a selective data finder to find data items associated with said relationships and ignore data items not related to said relationships such that only said found data are used in assigning quantitative values to said relationships and associating said quantitative values with said associated inputs and outputs.

33. The knowledge engineering tool as in claim 31 further comprising automatic initial layout functionality for arranging said inputs and outputs as interconnections between said cells and independent inputs and independent outputs in accordance with an a priori structural knowledge of said system.

34. The knowledge engineering tool as in claim 33 wherein said automatic initial layout functionality is configured to derive layout information from any one of a group consisting of process flow diagrams, process maps, structured questionnaire charts and layout drawings of said system.

35. The knowledge engineering tool as in claim 31 wherein at least one of said inputs is selected from the group consisting of a measurable input and a controllable input.

36. The knowledge engineering tool as in claim 31, wherein an output of a first of said interconnection cells comprises an input to a second of said interconnection cells.

37. The knowledge engineering tool as in claim 36 wherein said output is a controllable output to said first interconnection cell and a measurable input to said second interconnection cell.

38. A machine readable storage device, carrying data for the construction of:
an object definer for converting user input into at least one cell having inputs and outputs,
a relationship definer for converting user input into relationships associated with said cells such that each said relationships is associatable with said cells via one of said inputs and outputs, and
a quantifier for analyzing a data set to be modeled to assign quantitative values to said relationships and to associate said quantitative values with said associated inputs and outputs, thereby to generate a quantitative model.

39. Machine readable storage device according to claim 38, wherein said quantitative model is a predictive model usable for decision making.

40. Data mining apparatus for using empirical data to model a process, comprising:
a data source storage for storing data relating to a process,
a functional map for describing said process in terms of expected relationships,
a relationship quantifier, connected between said data source storage and said functional process map, for utilizing data in said data storage to associate quantities with said expected relationships,
thereby to provide quantified relationships to said functional map, thereby to model said process.

41. Apparatus according to claim 40, further comprising a functional map input unit for allowing users to define said expected relationships, thereby to provide said functional map.

42. Apparatus according to claim 40, further comprising a relationship validator associated with said relationship quantifier to delete relationships from said model having quantities not reaching a predetermined threshold.

43. Apparatus for obtaining new information regarding a process having an associated empirical data set, the apparatus comprising:
an object definer for converting user input into at least one cell having inputs and outputs,
a relationship definer for converting user input into relationships associated with said cells such that each said relationships is associatable with said cells via one of said inputs and outputs,
a quantifier for analyzing said associated empirical data set to assign quantitative values to said relationships and to associate said quantitative values with said associated inputs and outputs, thereby to generate a quantitative model, said quantitative values comprising new information of said process.

44. Apparatus according to claim 43, further comprising a verifier for verifying at least one relationship, said verifier comprising determination functionality for determining whether said associated quantitative value is above a threshold value and deletion functionality for deleting said associated input or output if said quantitative value is below said threshold value.

45. Apparatus according to claim 43, wherein said quantifier comprises a statistical data miner.

46. Apparatus according to claim 43, wherein said quantifier comprises functionality for any one of a group including: linear regression, nearest neighbor, clustering, process output empirical modeling (POEM), classification and regression tree (CART), chi-square automatic interaction detector (CHAID) and neural network empirical modeling.

47. Apparatus according to claim 43, wherein said data is a predetermined empirical data set of said process.

48. Apparatus according to claim 43, wherein said process comprises any one of a group comprising a biological process, sociological process, a psychological process, a chemical process, a physical process and a manufacturing process.

49. A method for automated decision-making by a computer comprising the steps of:
(i) modeling of relations between a plurality of objects, each object among said plurality of objects having at least one outcome, each object among said plurality of objects being subjected to at least one influential factor possibly affecting said at least one outcome;
(ii) data mining in datasets associated with said modeled relations between said at least one outcome and said at least one influential factor of at least one object among said plurality of objects;
(iii) building a quantitative model to predict a score for said at least one outcome, and
(iv) making a decision according to said score of said at least one outcome of said at least one object.
